(19) United States
(12) Patent Application Publication
(10) Pub. No.: US 2026/0319410 A1
(43) Pub. Date: Oct. 15, 2026

(54) IMAGE FORMING APPARATUS, DISPLAY METHOD, AND STORAGE MEDIUM

(71) Applicant: CANON KABUSHIKI KAISHA, Tokyo (JP)

(72) Inventor: YOSHIJI KANAMOTO, Tokyo (JP)

(21) Appl. No.: 19/638,614

(22) Filed: Apr. 3, 2026

(30) Foreign Application Priority Data
Apr. 9, 2025 (JP) 2025-064131

(51) Int. Cl. G03G 15/00

(52) U.S. Cl. CPC G03G 15/5029; G03G 15/5016; G03G 2215/00734; G03G 2215/00742; G03G 2215/00751

(57) ABSTRACT

In an image forming apparatus according to the present disclosure, a display unit displays, among a plurality of pieces of sheet information registered by a registration unit, sheet information registered by a measurement unit measuring properties of a sheet and sheet information registered through a setting performed by a user without the measurement unit measuring the properties of a sheet in a manner that enables their registration methods to be distinguished.

### BACKGROUND

### Field of the Technology

The present disclosure relates to an image forming apparatus, a display method, and a storage medium.

### Description of the Related Art

Japanese Patent Laid-Open No. 2025-29476 describes a technique for detecting the grammage and surface properties of a sheet using a medium sensor in an image forming apparatus such as a multifunction peripheral (MFP) or the like, and registering sheet information based on the results of the detection.

A user with little knowledge about media tends to simply register sheet information using a medium sensor, and a user with much knowledge about media tends to accurately register sheet information through user settings. Thus, there is an issue that if sheet information registered using a medium sensor and sheet information registered through user settings are displayed without distinction, it is difficult for a user to select desired sheet information.

### SUMMARY

In view of the above issue, the present disclosure is directed to making it easy for a user to select desired sheet information.

According to an aspect of the present disclosure, an image forming apparatus includes at least one memory storing instructions; and at least one processor that, upon execution of the stored instructions, configures the at least one processor to operate as: a measurement unit configured to measure properties of a sheet, a registration unit configured to register sheet information, a display unit configured to display a plurality of pieces of sheet information registered by the registration unit, and a printing unit configured to print an image on a sheet based on sheet information selected from the displayed plurality of pieces of sheet information, wherein the display unit displays sheet information registered by the measurement unit measuring properties of a sheet as automatically registered sheet information and displays sheet information registered through a setting performed by a user without the measurement unit measuring the properties of a sheet as manually registered sheet information, and wherein, in a case where a parameter of the sheet information displayed as the automatically registered sheet information is changed by the user inputting a parameter, the display unit displays the sheet information as the manually registered sheet information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an entire print system according to a first embodiment.

FIG. 2 is a hardware configuration diagram of an image forming apparatus according to the first embodiment.

FIG. 3 is a hardware configuration diagram of an information processing apparatus according to the first embodiment.

FIG. 4 is a software configuration diagram of the image forming apparatus according to the first embodiment.

FIG. 5 is a software configuration diagram of the information processing apparatus according to the first embodiment.

FIG. 6 is a diagram illustrating placement of medium type detection units according to the first embodiment.

FIG. 7 is a diagram illustrating a workflow related to a medium registration process.

FIG. 8A illustrates an example of a screen of medium registration using an operation section according to the first embodiment.

FIG. 8B illustrates an example of the screen of medium registration using the operation section according to the first embodiment.

FIG. 8C illustrates an example of the screen of medium registration using the operation section according to the first embodiment.

FIG. 8D illustrates an example of the screen of medium registration using the operation section according to the first embodiment.

FIG. 8E illustrates an example of the screen of medium registration using the operation section according to the first embodiment.

FIG. 8F illustrates an example of the screen of medium registration using the operation section according to the first embodiment.

FIG. 8G illustrates an example of the screen of medium registration using the operation section according to the first embodiment.

FIG. 8H is an example of the screen of medium registration using the operation section according to the first embodiment.

FIG. 8I illustrates an example of the screen of medium registration using the operation section according to the first embodiment.

FIG. 8J illustrates an example of the screen of medium registration using the operation section according to the first embodiment.

FIG. 8K illustrates an example of the screen of medium registration using the operation section according to the first embodiment.

FIG. 8L illustrates an example of the screen of medium registration using the operation section according to the first embodiment.

FIG. 8M illustrates an example of the screen of medium registration using the operation section according to the first embodiment.

FIG. 9A illustrates an example of a screen of medium registration using a web browser according to the first embodiment.

FIG. 9B illustrates an example of the screen of medium registration using the web browser according to the first embodiment.

FIG. 9C illustrates an example of the screen of medium registration using the web browser according to the first embodiment.

FIG. 9D illustrates an example of the screen of medium registration using the web browser according to the first embodiment.

FIG. 9E illustrates an example of the screen of medium registration using the web browser according to the first embodiment.

FIG. 9F illustrates an example of the screen of medium registration using the web browser according to the first embodiment.

FIG. 10 illustrates an internal configuration of a medium management table according to the first embodiment.

FIG. 11 is a flowchart of a medium management process according to the first embodiment.

FIG. 12 is a flowchart of a medium list display process according to the first embodiment.

FIG. 13 is a flowchart of a medium information display process according to the first embodiment.

FIG. 14 is a flowchart of a medium registration process according to the first embodiment.

FIGS. 15A-15C illustrate examples of medium editing screens displayed on an operation section according to a second embodiment.

FIG. 16 illustrates an example of an internal configuration of a medium management table according to the second embodiment.

FIG. 17 is a flowchart of a medium list display process according to the second embodiment.

FIG. 18 is a flowchart of a medium management process according to the second embodiment.

### DESCRIPTION OF THE EMBODIMENTS

Embodiments of the present disclosure will be described in detail below with reference to the drawings. The following embodiments do not limit the disclosure according to the appended claims, and not all the combinations of the features described in the embodiments are essential for a means for solving an issue.

### First Embodiment

First, a first embodiment of the present disclosure is described.

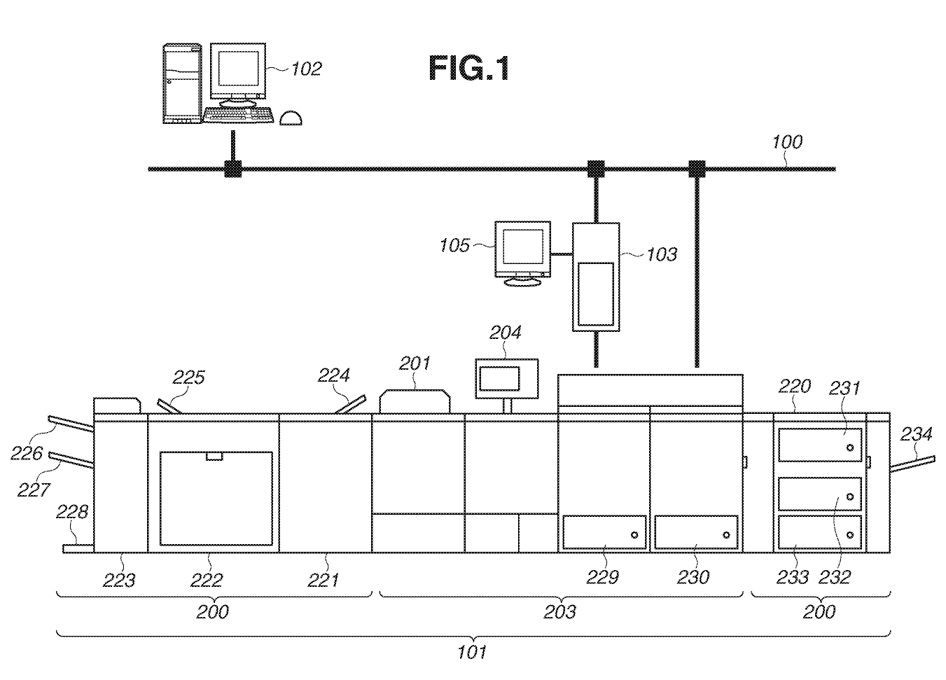

FIG. 1 is a block diagram illustrating a print processing system according to the present embodiment. In the present embodiment, a multifunction peripheral (MFP) 101 is described as an example of an image forming apparatus, and a personal computer (PC) 102 is described as an example of an information processing apparatus. The MFP 101 and the PC 102 are connected together via a network 100 so that the MFP 101 and the PC 102 can communicate with each other.

Although FIG. 1 illustrates a case where a single information processing apparatus is provided in the print processing system, the MFP 101 and a plurality of information processing apparatuses may be connected together via the network 100 so that the MFP 101 and the plurality of information processing apparatuses can communicate with each other. Although FIG. 1 illustrates a case where the print processing system according to the present embodiment includes the image forming apparatus and the information processing apparatus, the print processing system is not limited to this. For example, the image forming apparatus may be the print processing system. Further, a configuration may be employed in which in the execution of an image forming process that can be executed by the MFP 101 alone, such as the printing of a copy job or a saved job or the like, the information processing apparatus being connected to the network 100 is unnecessary.

First, the PC 102 is described. The PC 102 can execute various programs such as an application program that submits a print job, and the like. On the PC 102, various applications such as a printer driver having the function of converting print data into a printer language supported by the MFP 101, workflow software, a web browser, and the like are installed. A user who wishes to perform printing can give a print instruction from the various applications. The printer driver, the workflow software, and the like can convert data output from an application based on the print instruction into print data that can be interpreted by the MFP 101, and transmit the print data to the MFP 101 connected to the network 100.

Although in the present embodiment, the PC 102 is illustrated as an example of the information processing apparatus, the information processing apparatus may be a mobile information terminal or the like such as a smartphone, a tablet terminal, or the like. The method for transmitting the print data to the image forming apparatus can be appropriately modified. The information processing apparatus may transmit the print data to the image forming apparatus via a printing application or driver, or the information processing apparatus may transmit the print data to the image forming apparatus via a cloud server.

Next, the MFP 101 is described. The MFP 101 has a reading function for reading an image on a sheet, and a print function for printing an image on a sheet. The MFP 101 also has post-processing functions for binding a plurality of sheets on which images are printed, aligning a plurality of sheets, and dividing the discharge destination of a plurality of sheets into a plurality of trays. Examples of a sheet include a sheet of paper such as plain paper, thick paper, coated paper, and the like, a film, and the like.

Although in the present embodiment, the MFP 101 is described as an example of the image forming apparatus, for example, the image forming apparatus may be a printer that does not have a reading function, or the like. In the present embodiment, as an example, the image forming apparatus includes various components described below.

Alternatively, a configuration may be employed in which a digital front end (DFE) 103 that is an apparatus having some of the functions included in the MFP 101 or other accompanying functions is added to the MFP 101. In this case, the PC 102 can regard the DFE 103 as providing the functions of the MFP 101 via the network 100 on behalf of the MFP 101. For example, the DFE 103 can be accompanied by various input/output devices similar to those included in the PC 102, such as a monitor 105 and the like.

In a system to which the DFE 103 is connected, the monitor 105 can be configured to be used as a display and operation unit for the DFE 103. The MFP 101 according to the present disclosure, however, can also be configured to use an operation section 204 as a display unit or an operation unit for the DFE 103.

The MFP 101 is configured so that devices having a plurality of different roles are linked to each other and can perform complex sheet processing. Components included in the MFP 101 are described below.

Based on image data, a printer section 203 forms (prints) an image using toner on a medium (a sheet) fed from a sheet feeding section. The configuration and the operating principle of the printer section 203 are as follows.

A light beam such as laser light or the like modulated according to image data is reflected by a rotary polygon mirror (a polygon mirror or the like), and a photosensitive drum is irradiated with the reflected laser light as scanning light. An electrostatic latent image formed on the photosensitive drum by the laser light is developed using toner, and this developed toner image is transferred to a sheet attached to a transfer drum. A series of operations of this image forming process is sequentially executed using toner of yellow (Y), magenta (M), cyan (C), and black (K), thereby forming a full-color image on the sheet. A configuration may be employed in which toner termed a spot color, transparent toner, or the like can be transferred in addition to these four colors. The sheet on the transfer drum on which the full-color image is formed in this manner is conveyed to a fixing device. The fixing device includes a roller, a belt, and the like and has a heat source such as a halogen heater or the like built into the roller. The fixing device melts by heat and pressure the toner on the sheet to which the toner image is transferred, thereby fixing the toner to the sheet.

The MFP 101 according to the present embodiment is also configured so that a printing speed mode, an image processing mode, a fixing temperature, and the like to be applied by the printer section 203 when performing printing are appropriately selected according to the sheet type and the grammage of a sheet to be used by the MFP 101 when performing a printing process.

The printer section 203 of the MFP 101 according to the present embodiment includes a scanner 201 and an operation section 204 placed on the upper surface of the printer section 203. The operation section 204 provides various interfaces in a case where, for example, a user makes various settings of the printer section 203 according to the present embodiment and performs various operations on the printer section 203 according to the present embodiment.

Further, the MFP 101 is configured so that in addition to the printer section 203, various accompanying devices can be attached to the MFP 101.

A large-capacity sheet feeding device 220 is a sheet feeding device attachable to and detachable from the printer section 203. The large-capacity sheet feeding device 220 includes a plurality of sheet feeding sections (231, 232, 233, and 234). This configuration enables the printer section 203 to perform a printing process on a large number of sheets.

A sensing unit 221 is a device that reads image information on a sheet, such as a test chart or the like created by the printer section 203, and makes various adjustments and the like. A configuration is employed in which the sheet read by the sensing unit 221 is discharged to a first escape tray 224 so that the test chart is not mixed with an output product as a normal final print product. The MFP 101 according to the present disclosure, however, is configured so that the sheet read by the sensing unit 221 can also be controlled to be discharged onto a tray included in a finishing device 223.

A stacker 222 is an output device configured to be able to stack a large number of output products printed by the printer section 203. A sheet subjected to printing is stacked in a tray provided in the output device. The MFP 101 according to the present disclosure is configured so that if there is a sheet that is not desired to be mixed with other sheets in the tray in the output device, the sheet can be discharged to a second escape tray 225.

A finishing device 223 is provided to perform stapling finishing on a bundle of a plurality of sheets. Examples of the type of the stapling can include binding processes in forms desired by the user, such as corner binding, two-point binding, saddle bookbinding, and the like. A configuration is employed in which a processed final product is discharged to a tray 226 or 227 in the case of corner binding or two-point binding, and on the other hand, is discharged to a tray 228 in the case of saddle bookbinding.

The MFP 101 can be divided into three major parts with the printer section 203 as a boundary. In FIG. 1, the devices placed to the right of the printer section 203 are referred to as "sheet feeding devices", and the sheet feeding devices mainly serve to continuously supply sheets stored within the sheet feeding devices to the printer section 203 at appropriate timings. For example, these devices also detect the remaining amounts of sheets stored within the devices. Sheet feeding sections (229 and 230) also exist within the printer section 203 and can execute functions equivalent to those of the sheet feeding devices. These sheet feeding sections included in the printer section 203 are also referred to as "sheet feeding devices" in the description.

On the other hand, in FIG. 1, the devices placed to the left of the printer section 203 are referred to as "sheet finishing devices". The sheet finishing devices are also referred to as "sheet processing devices" or "post-processing devices". The sheet finishing devices perform the process of, for example, performing various finishing processes on sheets on which a printing process is completed, or accumulating the sheets. The sheet feeding devices and the sheet finishing devices are collectively referred to as a "sheet processing device 200" in the following description. The sensing unit 221 is a unit that does not perform a finishing process on a sheet subjected to printing, but processes image information on a sheet subjected to printing, and therefore is described as a type of sheet finishing device in the present embodiment.

Next, the configuration (mainly the software configuration) of the MFP 101 according to the present embodiment is described.

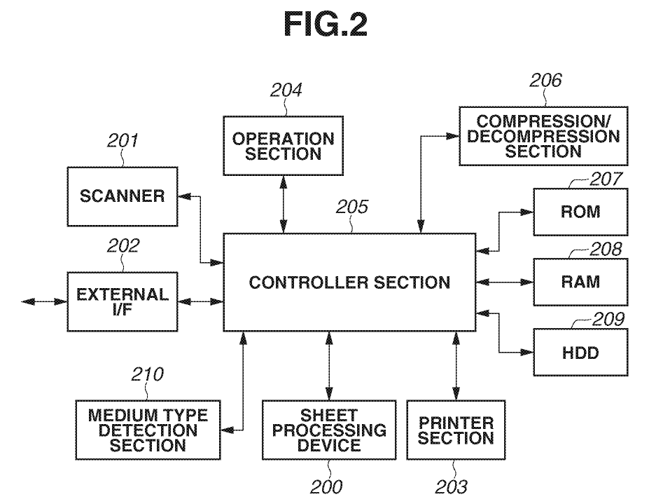

FIG. 2 is a functional block diagram illustrating the functional configuration of the MFP 101 according to the first embodiment. Since the blocks illustrated in FIG. 2 are divided in units as a system, there are portions that do not necessarily correspond to the units of the device configuration illustrated in FIG. 1.

The MFP 101 includes a non-volatile memory, such as a hard disk (hereinafter, hard disk drive (HDD)) 209 or the like, that stores data for a plurality of jobs as processing targets within the MFP 101. Although in the present embodiment, an example of the MFP 101 using a hard disk is illustrated, the non-volatile memory is not limited to a hard disk as long as a similar large-capacity and non-volatile storage device is used.

The MFP 101 also has a copy function for storing data received from the scanner 201 in the HDD 209, reading the data from the HDD 209, and printing the data in the printer section 203. The MFP 101 also has a print function for storing job data received from an external apparatus via an external interface (I/F) 202 as an example of a communication section in the HDD 209, reading the job data from the HDD 209, and printing the job data in the printer section 203, or the like. The MFP 101 is a multifunction processing apparatus (an MFP) (also referred to as an "image forming apparatus") including a plurality of functions as described above. The MFP 101 may be able to either perform color printing or perform monochrome printing.

The scanner 201 reads an image of a document, performs image processing on image data obtained by reading the document, and outputs the resulting image data. The external I/F 202 transmits and receives image data and the like to and from a facsimile machine, a network connection device, or an external dedicated apparatus. The HDD 209 also stores various pieces of management information and the like permanently stored, changed, and managed by the MFP 101. The MFP 101 also includes the printer section 203 that executes a printing process for printing data for a job as a printing target stored in the HDD 209.

The MFP 101 also includes the operation section 204 corresponding to an example of a user interface section and including a display section. A controller section (control section) 205 corresponding to an example of a control section included in the MFP 101 includes a central processing unit (CPU) (not illustrated) and performs overall control of the processing, the operations, and the like of various units included in the MFP 101.

A read-only memory (ROM) 207 stores various control programs necessary in the present embodiment including programs for executing various processes and the like illustrated in flowcharts described below that are executed by the controller section 205. The ROM 207 also stores a display control program for causing the display section of the operation section 204 to display various user interface screens (hereinafter, "UI screens"), and the like.

The MFP 101 executes various operations according to the present embodiment by the CPU of the controller section 205 reading programs stored in the ROM 207 and executing the programs. The ROM 207 also stores a program for the controller section 205 to perform the operation of interpreting page description language (hereinafter abbreviated as "PDL") data received from an external apparatus via the external I/F 202 and rasterizing the PDL data into raster image data (bitmap image data), and the like. Similarly, the ROM 207 also stores a program for the controller section 205 to interpret and process a print job received from an external apparatus via the external I/F 202, and the like. These programs are processed by software. The ROM 207 is a read-only memory and stores in advance various programs such as programs for a boot sequence, font information, and the like, the above programs, and the like. The details of the various programs stored in the ROM 207 will be described below. A random-access memory (RAM) 208 is a readable and writable memory and stores image data sent from the scanner 201 or the external I/F 202, various programs, setting information, and the like.

The controller section 205 also controls the operation of the sheet processing device 200. The sheet processing device 200 corresponds to the sheet feeding devices and the sheet finishing devices described with reference to FIG. 1.

The HDD 209 also stores image data compressed by a compression/decompression section 206. The HDD 209 is configured to be able to hold a plurality of pieces of data such as print data for a job as a processing target and the like.

The controller section 205 stores data for a job as a processing target input via various input units such as the scanner 201, the external I/F 202, and the like in the HDD 209, reads the data from the HDD 209, outputs the data to the printer section 203, and prints the data in the printer section 203. The controller section 205 also performs control so that job data read from the HDD 209 can be transmitted to an external apparatus via the external I/F 202. As described above, the controller section 205 executes various output processes on data of a job as a processing target stored in the HDD 209. The controller section 205 is also configured to read various programs stored in the ROM 207 and control the MFP 101 based on processes described in the programs.

The compression/decompression section 206 compresses or decompresses image data or the like stored in the RAM 208 or the HDD 209, based on various compression methods such as Joint Bi-level Image Experts Group (JBIG), Joint Photographic Experts Group (JPEG), and the like.

A medium type detection section 210 is a medium sensor that measures the properties of a sheet to be used when the MFP 101 executes a printing process, such as the sheet type, the grammage, the surface property, and the like of the sheet, using sensors. Specifically, the MFP 101 measures the grammage of the sheet using an ultrasonic sensor included in the medium sensor and measures the surface property of the sheet using an image sensor such as a contact image sensor (CIS) or the like included in the medium sensor. In the MFP 101 according to the present disclosure, the medium sensor is installed on a sheet conveyance path within the MFP 101. The placement of the medium type detection section 210 within the MFP 101 and the configuration of the medium type detection section 210 will be described below.

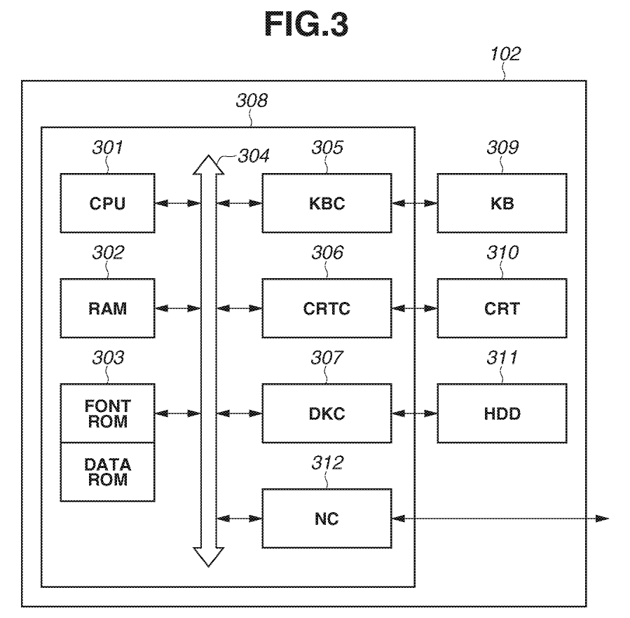

FIG. 3 is a block diagram illustrating the configuration of the PC 102 according to the first embodiment.

In FIG. 3, a CPU 301 executes programs for an operating system (OS), a general application, and a bookbinding application that are stored in a program ROM of a ROM 303 or loaded from an HDD 311 into a RAM 302, and the like. The ROM 303 is also used as a font ROM and a data ROM. The RAM 302 functions as a main memory, a work area, and the like for the CPU 301. A keyboard controller (KBC) 305 controls an input from a keyboard 309 or a pointing device (not illustrated).

A display controller 306 controls display on a display section 310. A disk controller (DKC) 307 controls access to the HDD 311 or the like that stores a boot program, various applications, font data, a user file, and the like. A network controller (NC) 312 is connected to the network 100 and performs the process of controlling communication with another device connected to the network 100. A bus 304 connects the CPU 301 to the RAM 302, the ROM 303, various controllers, and the like, thereby conveying a data signal and a control signal.

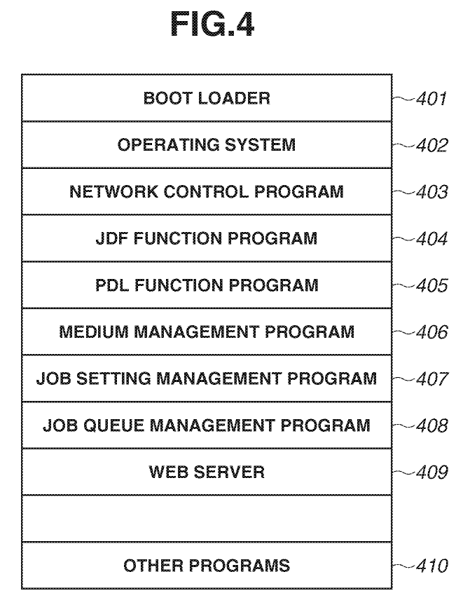

FIG. 4 is a diagram illustrating programs for the MFP 101 according to the first embodiment. These programs are stored in the ROM 207 and read and executed by the controller section 205 of the MFP 101.

A boot loader 401 is a program executed immediately after the MFP 101 is powered on.

These programs include a program for executing various start-up sequences required to start the system.

An operating system 402 is a program intended to provide an execution environment for various programs for achieving the functions of the MFP 101. The operating system 402 mainly provides the functions of, for example, managing the resources of the memories of the MFP 101, i.e., the ROM 207, the RAM 208, the HDD 209, and the like, and performing basic input/output control of the other components illustrated in FIG. 2.

A network control program 403 is a program executed when data is transmitted to and received from a device connected to the MFP 101 via the network 100. The network control program 403 is used when a reception process for receiving a file to be printed is performed, or when data is transmitted from an external apparatus, or when a command is transmitted and received. The network control program 403 also includes a device driver program for controlling the external I/F 202.

A Job Definition Format (JDF) function program 404 is a program for, if JDF job data is received by the MFP 101 via the external I/F 202, executing a JDF print function executed by the controller section 205 according to an instruction from the external I/F 202. In the JDF print function, the controller section 205 sequentially instructs the devices illustrated in FIG. 2 to operate in an appropriate order based on a processing order and a processing condition described in the JDF function program 404. This results in controlling a JDF print process to be ultimately executed. The devices include the sheet processing device 200, the printer section 203, the HDD 209, the compression/decompression section 206, the RAM 208, and the like. The JDF print process also includes an analysis process for analyzing JDF job data received via the external I/F 202, a determination process for, as a result of the analysis process, determining whether the JDF job data includes an incorrect setting, and a program process for changing settings to remove the incorrect setting, and the like.

A PDL function program 405 is a program for, if PDL data (printing target image data) is received by the MFP 101 via the external I/F 202, performing a PDL function for performing a rasterization process for rasterizing the PDL data and a print function that are executed by the controller section 205. In the PDL function performed by the controller section 205, the controller section 205 sequentially instructs the devices illustrated in FIG. 2 to operate in an appropriate order based on a processing order and a processing condition described in the PDL function program 405. This results in controlling a PDL print process to be ultimately executed. These devices include the sheet processing device 200, the printer section 203, the HDD 209, the compression/decompression section 206, the RAM 208, and the like. The PDL function program 405 according to the present embodiment is configured to operate with the JDF function program 404 as an analysis unit for analyzing various job setting formats when a printing process is executed.

A medium management program 406 is a program for performing a management function related to sheets that can be used by the MFP 101. Sheet-related information managed by the medium management program 406 is stored in the HDD 209. The medium management program 406 can provide a medium management function for, for example, registering a new medium, holding registration information, and deleting an unnecessary medium. The medium management program 406 also has the function of, for example, changing the settings of a registered medium, and also adjusting a medium that has not yet been adjusted and updating information regarding the adjusted medium as an optimized medium.

Further, the MFP 101 according to the present embodiment may have an example of a configuration in which the MFP 101 also has a management function for, for example, exporting medium information to outside the MFP 101, such as the PC 102, via the external I/F 202, or importing medium information from the PC 102.

The sheet-related information managed by the medium management program 406 is also managed in association with information regarding print job settings applicable when printing is performed. The medium management program 406 also manages what media are set in the plurality of sheet feeding sections (229, 230, 231, 232, 233, and 234) included in the MFP 101.

In the MFP 101 according to the present disclosure, two types of units are mainly provided as medium registration units. A first unit is a unit termed manual registration in which a skilled person optimizes a medium by, for example, registering the medium and making related adjustments using the operation section 204 and completes a registration process. A second unit is a unit in which an unskilled person simply executes a registration process using a medium sensor. Various control units required for both of these registration units are also provided by executing the medium management program 406. The details of the medium registration processes performed by the medium management program 406 will be described below.

A job setting management program 407 is a program for controlling various settings regarding a print job executed by the MFP 101. Specifically, the job setting management program 407 is used to perform control to, for example, change setting information regarding a print job, detect and remove a conflicting state between settings, and control screens required for these operations.

A job queue management program 408 is a program for performing various types of control regarding the execution order of print jobs to be executed by the MFP 101. The job queue management program 408 provides the functions of, for example, managing a queue for a print job, executing and stopping the sequence of a print job, and calculating job scheduling for estimating the execution time of a job.

A web server 409 is a program for processing a request based on a HyperText Markup Language (HTML) protocol from a web browser or the like executed by an external apparatus such as the PC 102 or the like. Consequently, for example, it is possible to give an instruction to perform a medium registration process or the like from an apparatus located at a remote location, such as the MFP 101 or the like, via the network 100 without physically operating the operation section 204, the monitor 105, or the like.

Other programs 410 are a collective term of programs not included in any of the above programs among programs that can be executed by the MFP 101 and are stored in the ROM 207. The other programs 410 are not important in describing the effects of the present disclosure, and therefore are not described.

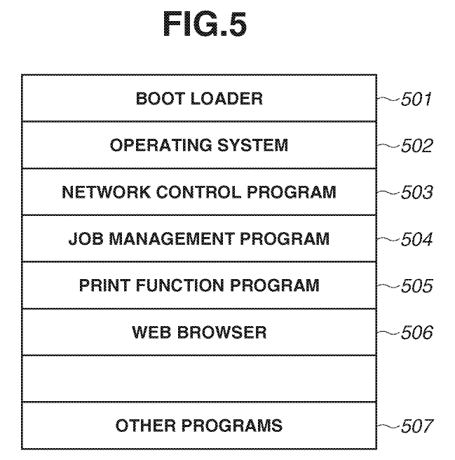

FIG. 5 is a diagram illustrating an example of the configuration of programs included in the PC 102 according to the first embodiment.

A boot loader 501 is a program executed immediately after the PC 102 is powered on. These programs include a program for executing various start-up sequences required to start the system.

An operating system 502 is a program intended to provide an execution environment for various programs for achieving the functions of the PC 102. The operating system 502 provides the functions of, for example, managing the resources of the memories of the apparatus, i.e., the ROM 303, the RAM 302, the HDD 311, and the like.

A network control program 503 is a program executed when data is transmitted to and received from a device connected to the PC 102 via the network 100. That is, the network control program 503 is used when print job data is transmitted to the MFP 101 and the MFP 101 is instructed to perform a printing process. The network control program 503 is also used to, for example, receive a print-data reception response from the MFP 101 or receive status. A web browser 506 also transmits and receives data to and from an external apparatus based on an HTML protocol using the network control program 503.

A job management program 504 is a program for managing a job transmitted from the PC 102 to the MFP 101. It is possible to execute various processes of, for example, managing a list of jobs in order of transmission, changing the order of jobs, temporarily stopping a job, cancelling a job, and changing a setting through the job management program 504.

A print function program 505 is executed when the PC 102 transmits a print job to the MFP 101 and instructs the MFP 101 to execute the print job through the network control program 503. For example, the print function program 505 also creates print job data and manages print settings.

A web browser 506 is a program for communicating with a web server operating on an external apparatus, and transmitting and receiving data to and from the web server through an HTML protocol. Information displayed on the web browser 506 includes a variety of information. For example, in the present embodiment, the information is configured to be able to be used when medium management in the MFP 101 is performed. The specific content of the medium management performed by the web browser 506 will be described below.

Other programs 507 are a collective term of programs not included in any of the above programs among programs included in the PC 102. The other programs 507 are not important in describing the effects of the present disclosure, and therefore are not described.

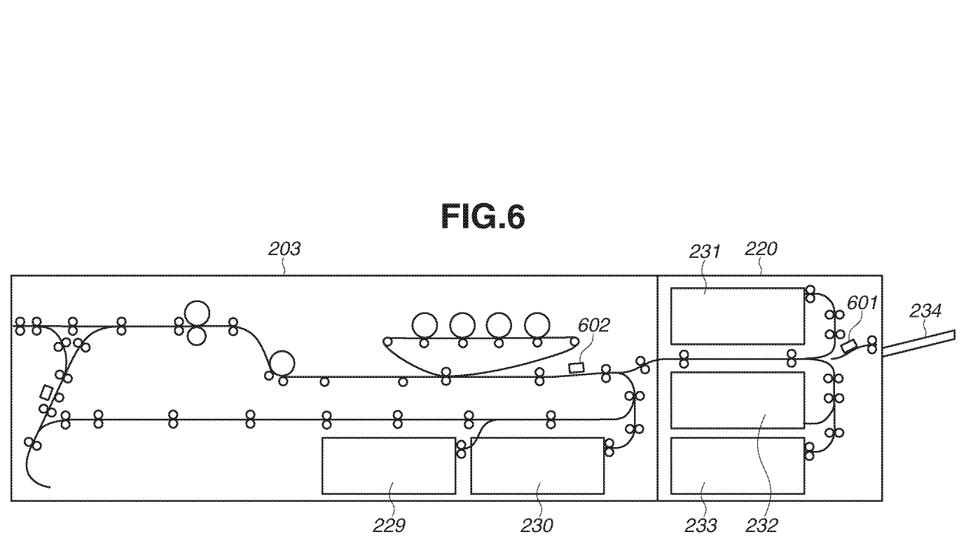

FIG. 6 is a diagram for describing the placement of sheet storage units and a sheet conveyance path within the printer section 203 and the large-capacity sheet feeding device 220, and the medium type detection section 210 installed on the conveyance path.

FIG. 6 illustrates an example of the MFP 101 including two medium type detection sections 210, namely a first medium type detection section 601 and a second medium type detection section 602. The first medium type detection section 601 is placed downstream of a sheet feeding section. The second medium type detection section 602 is placed upstream of an image forming section and downstream of all the sheet feeding sections (229, 230, 231, 232, 233, and 234) included in the MFP 101.

Because of the placement of the first medium type detection section 601, the first medium type detection section 601 can perform an automatic detection process only on a sheet fed from the sheet feeding section 234 as a target. On the other hand, the second medium type detection section 602 can perform an automatic detection process on sheets fed from all the sheet feeding sections (229, 230, 231, 232, 233, and 234) as targets.

In either of the above detection units, i.e., the first medium type detection section 601 and the second medium type detection section 602, to detect property information regarding a medium, such as the sheet type and the grammage of the medium, it is necessary to feed a sheet and convey the sheet to the position of the detection section.

As a mechanism for the medium sensors (601 and 602) to detect property information regarding a medium, such as the grammage and the medium type of the medium, there are mechanisms using a variety of techniques. Examples of the mechanism include a unit for emitting an ultrasonic wave to a sheet using an ultrasonic wave generation unit, measuring the transmittance of the ultrasonic wave using an ultrasonic sensor, and detecting the grammage of the sheet, and the like. Examples of the mechanism also include a unit for reading the surface of a sheet using a CIS, distinguishing the sheet type based on the results of analyzing the unevenness, the color, the reflectance, and the like of the surface of the sheet, and the like.

The present disclosure is not limited to the above examples as the detection units for detecting the medium type and the grammage, and assumes an example where the medium type and the grammage can be detected using any technique. Thus, the present disclosure is effective regardless of the types or schemes of the detection units as long as the items described in the claims are satisfied.

In the MFP 101 according to the present embodiment, the medium sensors (601 and 602) are each used as a simple unit for medium registration, i.e., a unit for an unskilled person to simply achieve a medium registration process using an automatic method. Thus, this unit eliminates the need to perform various cumbersome processes regarding medium registration, i.e., various adjustments regarding manual registration to be performed by a skilled person using the operation section 204, and the like. That is, a configuration is employed in which only information that can be detected by the detection units is used as attribute information when a medium is registered, and therefore, the medium can be simply registered in the MFP 101 without involving other attribute information, adjustments, and the like that require skills.

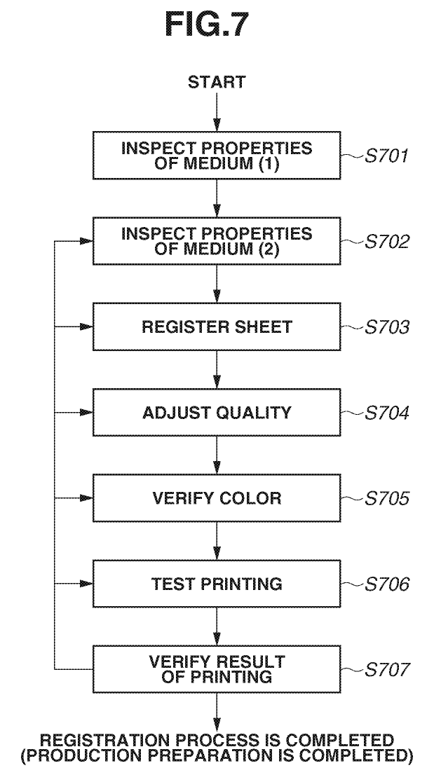

FIG. 7 is a diagram for describing the content and the flow of general processing performed when a medium registration process is performed by the skilled person through the operation section 204. The diagram illustrated in FIG. 7 illustrates an example of processing performed by the skilled person, and is not limited to the diagram illustrated in FIG. 7.

First, in step S701, to inspect the properties of a medium, information obtained from product information made publicly available by the paper manufacturer, or the like is inspected regarding various properties of the medium.

Further, in step S702, a real medium is obtained in addition to the inspection based on the information, and a more detailed inspection regarding property information regarding the medium is performed also taking into account the properties such as the appearance, the feel, and the like of the medium.

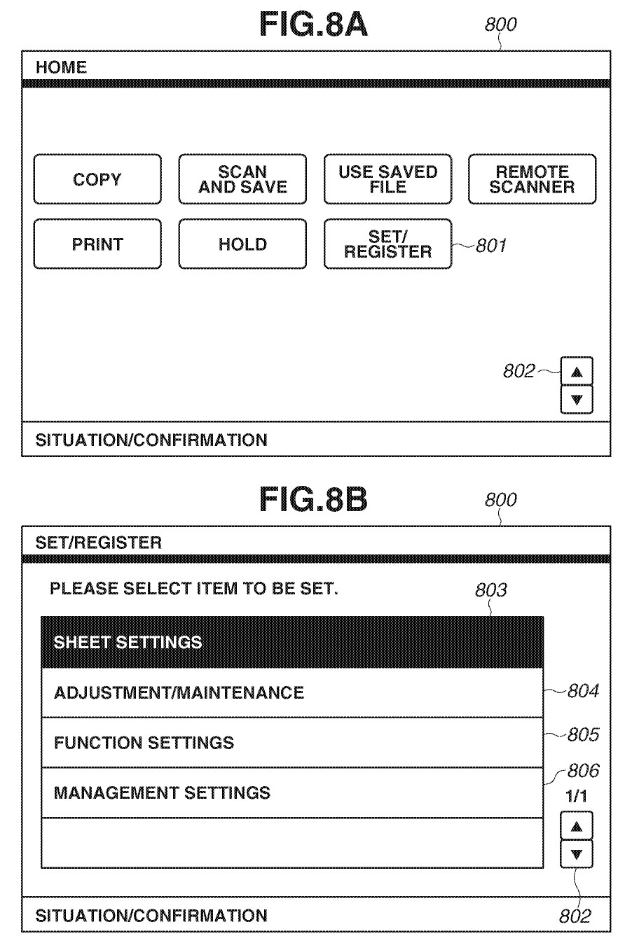

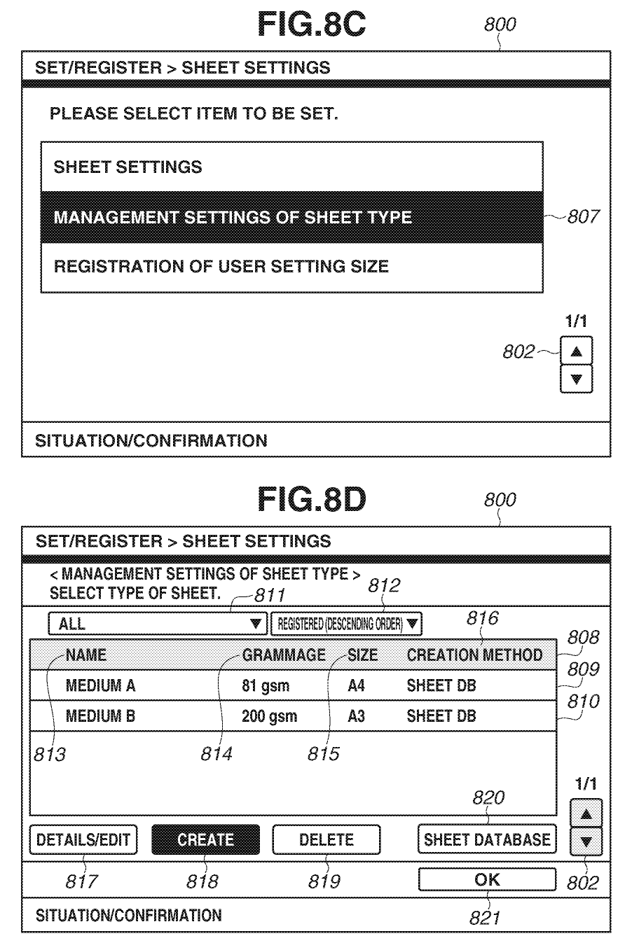

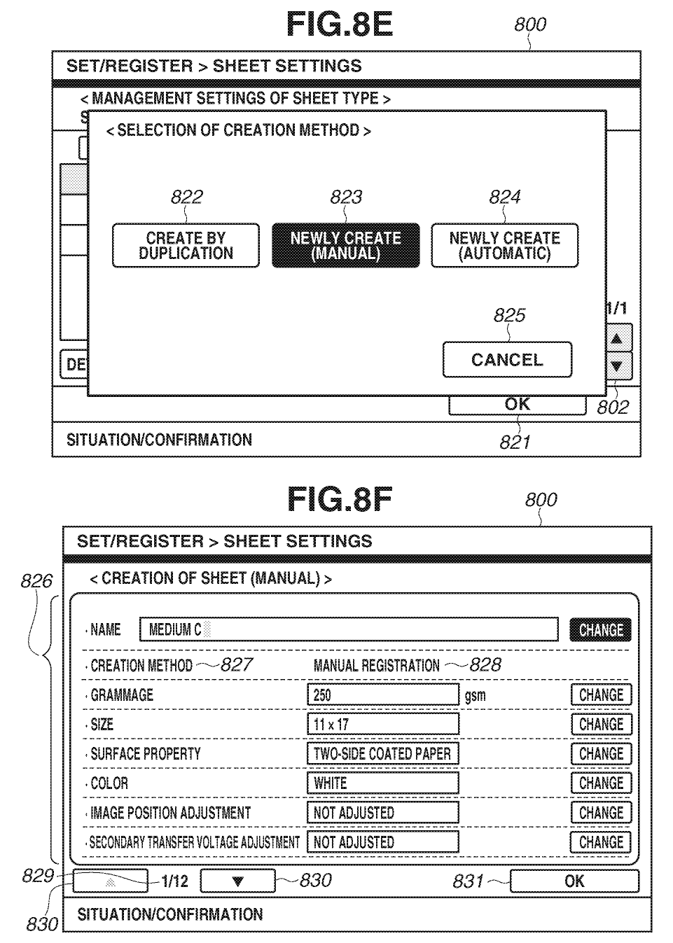

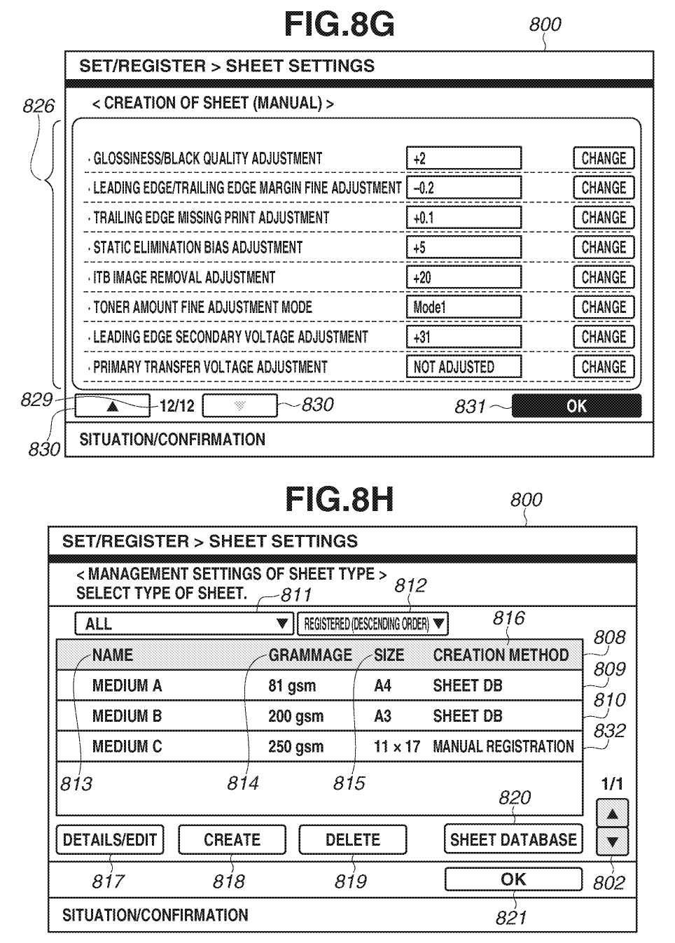

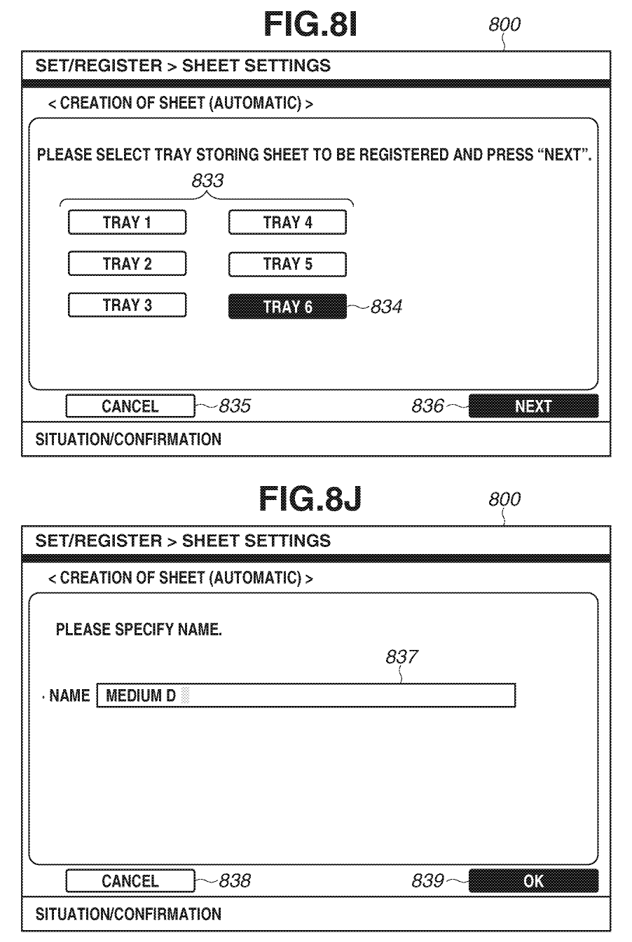

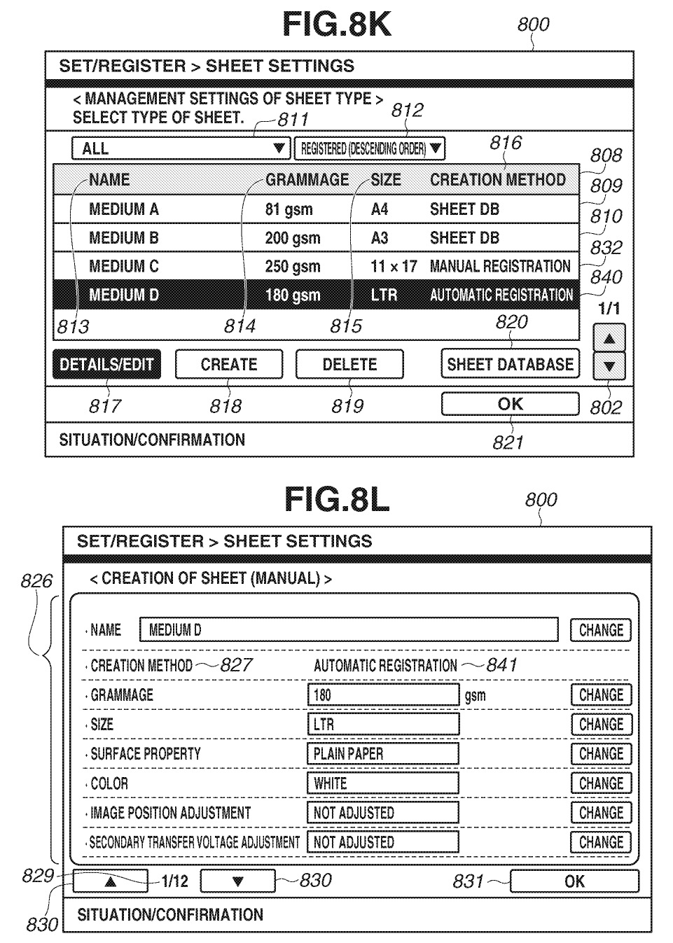

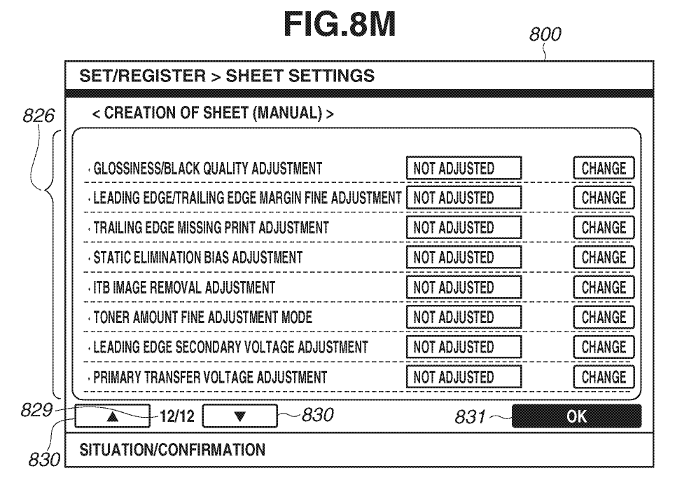

In step S703, based on the results of the inspections, a registration process for registering the medium (sheet information) in the MFP 101 is performed. The sheet information registered in this case includes the grammage of the sheet, the type of the sheet, the size of the sheet, a secondary transfer voltage, and the like. The sheet information registered in this case may be stored in the HDD 209 of the MFP 101, or may be stored in a storage section such as an HDD or the like of the DFE 103. This registration process is a manual registration process in FIGS. 8A-8M. The details of the manual registration process will be described below with reference to FIGS. 8A-8M. The manual registration process refers to the process of registering the sheet information in the MFP 101 not by a simple registration method using the medium type detection section 210 (automatic registration), but by the user inputting parameters through the operation section 204 based on the information obtained in the above steps.

In the next and subsequent steps, further various adjustment processes are performed to obtain a desired result when the registered medium is used. In step S704, the paper type, the grammage, and the geometric properties of the medium are adjusted, and further, in a case where the MFP 101 uses an electrophotographic method, the transfer voltage of toner, the gloss of a toner image to be formed on the medium as a result of the transfer of the toner, and the like are adjusted. These adjustments correspond to the act of making adjustments to obtain a desired quality and a desired result while changing various attribute values (parameters) associated with the medium or the combinations of the various attribute values. The various attribute values (parameters) set in this case are also included in the sheet information.

Next, in step S705, a color verification process is performed to verify that the color quality of an image to be formed on the medium corresponding to the registered sheet information is as expected or falls within an expected range. In step S706, test printing is executed using the registered medium in the state where the registered medium is subjected to the above processes. In step S707, the result of the test printing is verified.

As described above, the series of processes regarding medium registration by the user is performed, and if it is confirmed that satisfactory results for actual production using this medium are obtained in the results of all the processes, this medium registration process is completed.

If an unsatisfactory result is confirmed in any of the above processes, the process of going back to this process or a process performed before this process, performing the same process by changing the conditions, and verifying the result of the process is repeatedly performed.

As described above, a plurality of cumbersome and complex processes is required to register a medium in the MFP 101 in the state where print quality can be guaranteed. Thus, it is difficult to register a medium in the MFP 101 in the state where print quality is guaranteed, except for an operator with skills to perform the flow illustrated in FIG. 7 based on correct knowledge and correctly verify the result of the flow.

Due to this situation, the medium type detection section 210 is mounted on the MFP 101 as a measure for decreasing the level of difficulty of registration of sheet information so that even a user without advanced skills can register sheet information.

Through the use of the medium type detection section 210, it is possible to register a medium in the MFP 101 in a simple form based on information automatically detected and measured by the sensors. The medium registered based on the automatically detected information, however, is not registered after being subjected to accurate adjustments as illustrated in FIG. 7.

In other words, there is a case where an operator aiming to use a medium strictly registered according to the flow in FIG. 7 to guarantee print quality wants to avoid using a medium simply registered by the medium type detection section 210. The present disclosure is directed to providing a method for enabling the distinction of what unit is used to register each medium in such a case, and preventing a medium from being misused as described above.

Moreover, the MFP 101 is used in a shared manner by a plurality of operators. Generally, a skilled person and an unskilled person are mixed together among these operators. If these mixed users each register a medium, this results in the state where a plurality of media registered by registrants with different skills is mixed together in the medium management program 406 of the MFP 101. This may interfere with a case where not only a user of the MFP 101 but also an administrator of the MFP 101 manages registered medium entries and then identifies a medium registered by a skilled person and a medium registered by an unskilled person. In the MFP 101 according to the present disclosure, however, a medium registered according to the flow in FIG. 7 and a medium simply registered by the medium type detection section 210 can be identified. Thus, this does not interfere with the above management.

FIGS. 8A-8M are diagrams for describing examples of a medium management setting screen displayed on the operation section 204 included in the MFP 101.

FIG. 8A illustrates an example of a screen 800 displayed on the operation section 204 included in the MFP 101. FIG. 8A illustrates the state where a plurality of function selection units for selecting various operations on the MFP 101 is placed. A "set/register" button 801 is an object selected to make various settings in the MFP 101. The MFP 101 according to the present embodiment is configured so that various medium-related settings for medium registration processes according to the present embodiment and the like are also made through the "set/register" button 801.

FIG. 8A also illustrates selection buttons corresponding to various functions in addition to the "set/register" button 801. Even if not all of these selection buttons can be displayed within the screen illustrated in FIG. 8A, the hidden function selection buttons can be operated by operating scroll buttons 802.

FIG. 8B is a diagram illustrating an example of the state of a screen displayed on the operation section 204 immediately after the "set/register" button 801 is selected in the state of the screen in FIG. 8A.

As illustrated in FIG. 8B, various setting items of the MFP 101 provided by the "set/register" button 801 are placed in a form in which the various setting items can be hierarchically selected. In the example illustrated in FIG. 8B, a "sheet settings" button 803, an "adjustment/maintenance" button 804, a "function settings" button 805, a "management settings" button 806, and the like are placed. The MFP 101 according to the present disclosure is also configured so that further detailed setting buttons are hierarchically provided by selecting each selection button.

FIG. 8C is a diagram illustrating an example of the state of a screen displayed on the operation section 204 immediately after the "sheet settings" button 803 is selected in the state of the screen in FIG. 8B.

As illustrated in FIG. 8C, items corresponding to a plurality of further sheet settings are provided under the "sheet settings" button 803, and a button 807 is provided as one of these items.

The button 807 is an object provided to perform various operations of, for example, registering, changing, and deleting a medium managed by the medium management program 406 included in the MFP 101.

FIG. 8D is a diagram illustrating an example of a sheet type setting screen displayed on the operation section 204 immediately after the button 807 is selected in the state of the screen in FIG. 8C. The roles of components and function selection objects provided in the screen illustrated in FIG. 8D are described below.

A registered medium display region 808 is a region for displaying media registered in the MFP 101 in a list. FIG. 8D illustrates an example of a case where only two media (a medium A (809) and a medium B (810)) are registered and information regarding these media is displayed.

As illustrated in FIG. 8D, the information regarding the media displayed in the medium display region 808 includes a name 813, a grammage 814, a size 815, a creation method 816, and the like. These items are obtained by displaying the combinations of the characteristics, i.e., the attributes (also referred to as "parameters"), of each medium stored in association with the medium.

However, since the medium attributes of the media registered in the MFP 101 are wide-ranging, it is not realistic to display all the medium attributes in the medium display region 808 illustrated in FIG. 8D. Thus, only some of the pieces of information (the medium attributes) to be frequently referred to when the media are displayed in a list are selectively displayed. When equivalent functions are presented using the web browser 506, a configuration can be employed in which more information than that illustrated in FIG. 8D can be presented because a screen region used to display information is less constrained.

The creation method 816 is described in further detail. The information indicated by the creation method 816 is information that enables the identification of what method is used to create each medium registered in the MFP 101. In the example illustrated in FIG. 8D, the creation method 816 of the medium A (809) and the medium B (810) is "sheet DB" as illustrated in FIG. 8D. "Sheet DB" indicates that the medium is created from a medium registered from the start in the MFP 101. That is, "Sheet DB" indicates that the medium A (809) and the medium B (810) are media that are not created by the user of the MFP 101, but are created by the manufacturer of the MFP 101 and registered in advance in the apparatus. In other words, sheet information set to "sheet DB" is sheet information created from a set of pieces of medium information created as a sheet database by the manufacturer of the MFP 101.

As information indicating a medium creation method other than "sheet DB", first, there is "manual registration" indicating a medium mainly created by a skilled person inputting parameters. Second, there is "automatic registration" indicating a medium mainly registered by an unskilled person simply automatically determining some of the medium attributes using the medium type detection section 210. The details of "manual registration" and "automatic registration" will be described below.

A "details/edit" button 817 is used to give an instruction to transition to a detailed screen for viewing the medium attributes regarding each medium displayed in the medium display region 808 or editing the attribute values of the medium attributes.

A "create" button 818 is selected to additionally register a new medium in the MFP 101. The operation when the "create" button 818 is selected will be described below.

A "delete" button 819 is used to delete an existing medium registered in the MFP 101 from the medium display region 808.

A sheet database selection button 820 is used to register, in the medium display region 808 illustrated in FIG. 8D, a medium registered in the database created in advance in the apparatus by the manufacturer of the MFP 101. That is, information displayed as the creation method 816 of a medium created by selecting the sheet database selection button 820 is "sheet DB".

An "OK" button 821 is used to complete an operation on the screen illustrated in FIG. 8D and give an instruction to transition to the screen in FIG. 8C.

FIGS. 8D and 8H each illustrate a screen for displaying a plurality of pieces of sheet information registered in the MFP 101 in a list. Each of the screens in FIGS. 8D and 8H may be displayed when the MFP 101 prints an image on a sheet based on a print job. For example, each of the screens in FIGS. 8D and 8H may be a screen that receives the selection of a sheet from the user when the MFP 101 executes copying. In this case, the printer section 203 prints an image on a sheet based on sheet information selected on the screen in FIGS. 8D or 8H by the user. Also in a case where the MFP 101 receives a print job from the PC 102 and executes the print job, a similar process may be executed.

FIG. 8E illustrates an example of the state of a screen displayed on the operation section 204 immediately after the "create" button 818 is selected in the state of the screen in FIG. 8D. As illustrated in FIG. 8E, medium creation methods based on three different forms in the system according to the present embodiment are provided.

A "create by duplication" button 822 is an object used to create a new medium by duplicating a medium registered in the MFP 101. The duplicated medium means a medium whose medium attributes, except for the name, are the same as those of the medium before the duplication, i.e., the medium as the reference source.

A "newly create (manual)" button 823 is an object used to register a new medium without duplicating an existing medium and not by the simple method using the medium type detection section 210. This object is provided as a suitable object when a skilled person generates an optimized medium through a plurality of various processes as illustrated in FIG. 7. While it is cumbersome to manually create sheet information as illustrated in FIG. 7, it is possible to create sheet information with a desired accuracy.

A "newly create (automatic)" button 824 is an object used to register a new medium without duplicating an existing medium and by the simple method using the medium type detection section 210. With this object, even a person without skills to execute processes as illustrated in FIG. 7 can create a medium and register the medium in the MFP 101 according to the present embodiment by a simple method. If a "cancel" button 825 is selected, a transition is made to the screen in FIG. 8D again.

FIG. 8F illustrates an example of the state of a screen displayed on the operation section 204 immediately after the "newly create (manual)" button 823 is selected in the state of the screen in FIG. 8E. As illustrated in FIG. 8F, entry fields 826 for various attributes regarding a medium to be newly created are provided.

However, since a transition is made to the state of the screen in FIG. 8F as a result of selecting the "newly create (manual)" button 823 in FIG. 8E, the value of the entry field 826 for a creation method 827 is fixed as "manual registration" 828, and the entry field 826 for the creation method 827 cannot be edited on this screen.

Also as illustrated in FIG. 8F, the medium attributes that cannot be displayed due to constraints on the display region in FIG. 8D can also be displayed and edited in this state.

The medium attributes in the MFP 101 are wide-ranging. Thus, all these medium attributes cannot be displayed at a time even on the screen illustrated in FIG. 8F. Thus, a configuration is employed in which a transition can be made to the state where a desired attribute can be viewed and edited by operating scroll buttons 830. A number-of-screens indicator 829 indicating the number of screens that are not displayed in this screen, but can be displayed and edited by operating the scroll buttons 830 is also placed. FIG. 8G illustrates an example of a screen displayed in a case where a display operation for displaying the medium attributes that cannot be displayed in the display region in FIG. 8F is performed by operating the scroll buttons 830.

The example illustrated in FIG. 8F illustrates a screen for providing the new creation of a medium using the "newly create (manual)" button 823. When the "newly create (manual)" button 823 is selected, a medium is created by a skilled operator determining appropriate values for the attributes of the medium by mustering their experience and knowledge in the process of executing the flow illustrated in FIG. 7.

An "OK" button 831 is used to give an instruction to complete an editing operation for editing the medium attributes in FIG. 8F.

FIG. 8H illustrates an example of a sheet type management setting screen in the state where the series of processes by the manual registration of a new medium using the "newly create (manual)" button 823 is completed through the screen transition illustrated up to FIG. 8G. As illustrated in FIG. 8H, in the medium display region 808, a medium C (832) as a result of operating the "newly create (manual)" button 823 is registered, and the creation method 816 of the medium C (832) is "manual registration". A configuration is employed in which it can be distinguished that the medium C (832) is a medium created using the "newly create (manual)" button 823.

Sheet information displayed as "manual registration" in this case is sheet information registered through the settings performed by the user without the medium type detection section 210 (a medium measurement unit) measuring the properties of the sheet. The settings performed by the user refers to the settings in some of the processes or the series of processes illustrated in the flow in FIG. 7. Specifically, sheet information registered by receiving the input of the setting values of the surface property, the grammage, the size, the secondary transfer voltage, and the like of the sheet through the screen in FIG. 8F is the sheet information displayed as "manual registration".

Sheet information displayed as "automatic registration" in this case is sheet information registered by the medium type detection section 210 (the medium measurement unit) measuring the properties of the sheet.

If a parameter of sheet information displayed as automatically registered sheet information is changed by the user inputting a parameter, the operation section 204 displays this sheet information as manually registered sheet information. That is, the operation section 204 displays the creation method 816 of the sheet information as "manual registration".

If sheet information is registered by duplicating sheet information displayed as automatically registered sheet information, the operation section 204 displays this sheet information as automatically registered sheet information. That is, the operation section 204 displays the creation method 816 of the sheet information as "automatic registration".

The operation section 204 of the MFP 101 displays automatically registered sheet information as "automatic registration" and manually registered sheet information as "manual registration" as illustrated in the screen in FIG. 8H, thereby distinguishably displaying the automatically registered sheet information and the manually registered sheet information.

"Automatic registration" and "manual registration" may be displayed in a case where a particular condition is satisfied. For example, this may be a case where the condition is satisfied that among pieces of registered sheet information, there are pieces of sheet information having similar names or the same name, at least one of these pieces of sheet information is automatically registered, and another one of these pieces of sheet information is manually registered.

If this condition is satisfied, the automatically registered sheet information and the manually registered sheet information are distinguishably displayed. If this condition is not satisfied, automatically registered sheet information and manually registered sheet information are not distinguishably displayed. That is, the pieces of sheet information are displayed with nothing displayed as the creation method 816.

Next, with reference to FIG. 8I and subsequent figures, the operation of automatically registering a medium using the medium type detection section 210 is described.

FIG. 8I illustrates an example of a medium automatic registration screen using the medium type detection section 210 displayed by a transition made after the "newly create (automatic)" button 824 is selected in the state of the screen in FIG. 8E.

As illustrated in FIG. 6, the MFP 101 according to the present embodiment has a mechanism for detecting sheets conveyed from the sheet feeding sections (229 to 234) to the medium sensors (601 and 602) provided on the conveyance path using the sensors, as the medium type detection section 210. Thus, as illustrated in FIG. 8I, storage tray specifying buttons 833 for registration target media for specifying trays storing sheets as automatic detection targets are provided. The example illustrated in FIG. 8I illustrates an example of a case where a button 834 for a tray 6 is selected.

If a "cancel" button 835 is selected, the automatic new creation process in FIG. 8I is suspended, and an instruction to transition to the screen in FIG. 8E is given. If a "next" button 836 is selected, the medium installed in the tray selected in FIG. 8I is detected by the medium sensors (601 and 602), and a transition is made to a further setting screen for registering the medium based on the result of the detection.

FIG. 8J illustrates an example of a screen to which a transition is made in a case where the "next" button 836 is selected in the state of the screen in FIG. 8I.

As illustrated in FIG. 8J, a medium name entry field 837 is provided. This is because even if the medium is automatically registered based on the result of the detection by the medium sensors (601 and 602), the name of the medium needs to be given by the registrant. The example illustrated in FIG. 8J illustrates an example of a case where the name is given as "medium D". If an "OK" button 839 is selected in this state, the registration process for registering the sheet information by the automatic new creation is completed. If, on the other hand, a "cancel" button 838 is selected, the setting content is discarded.

FIG. 8K illustrates an example of the state of the medium display region 808 immediately after the new medium is automatically registered using the "newly create (automatic)" button 824 through the screen transition based on the series of setting operations illustrated up to FIG. 8J. It can be distinguished from FIG. 8K that a medium D (840) is added to the registered medium display region 808, and a medium regarding which the creation method 816 is displayed as "automatic registration" is registered.

FIG. 8K illustrates the following. By reference to the information in the fields of the creation method 816 regarding a plurality of media registered in the MFP 101, it can be identified what method is used to register each medium in the MFP 101.

FIG. 8L illustrates an example of the state of a screen when the new medium is registered using the "newly create (automatic)" button 824 through the operations up to FIG. 8K and in a case where the attributes of the automatically registered medium are referred to by selecting the "details/edit" button 817.

As illustrated in FIG. 8L, it can be distinguished from FIG. 8L that the creation method 827 is "automatic registration" 841. This is the same content as that in the display state in FIG. 8K.

Values input to the entry fields 826 for various attributes illustrated in FIGS. 8L and 8M include some information determined based on information sensed by the sensors included in the medium type detection section 210, i.e., the medium sensors (601 and 602).

However, the medium is created in the state where the attributes other than those determined by the sensing remain unchanged as initial values. In other words, unlike the situation illustrated in the example where a medium is created using the "newly create (manual)" button 823, this is not a state equivalent to that of a medium created as a result of a skilled person storing appropriate attribute values through the various operations illustrated in FIG. 7.

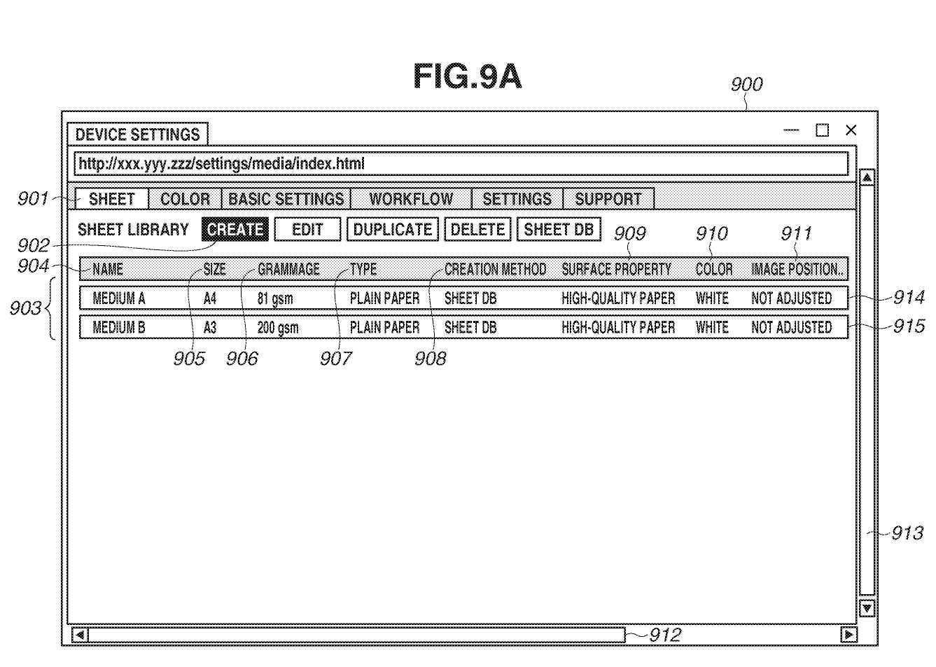

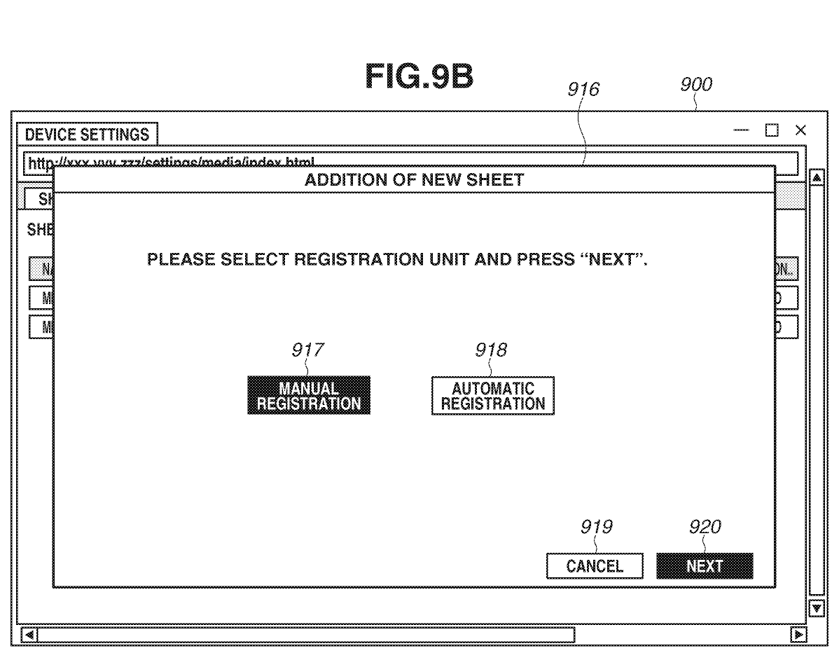

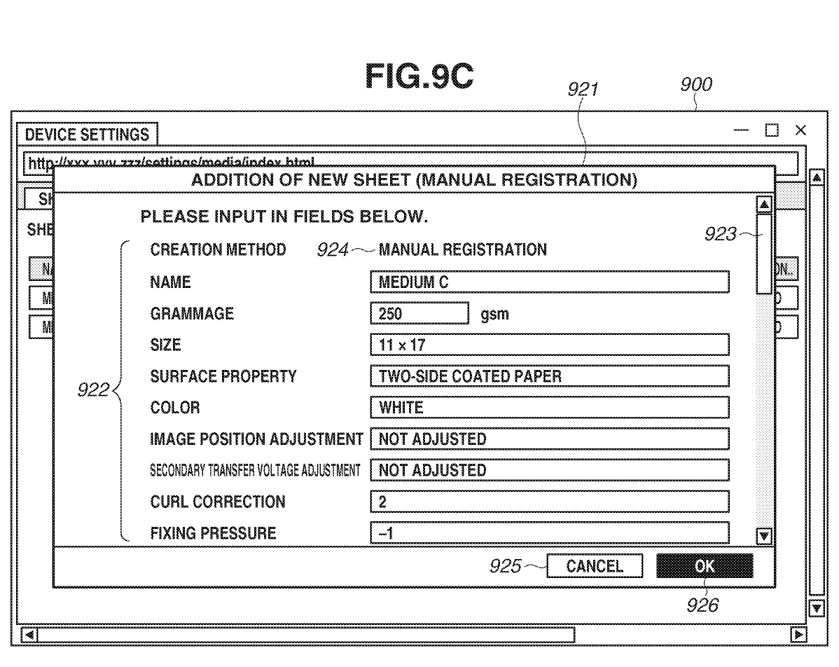

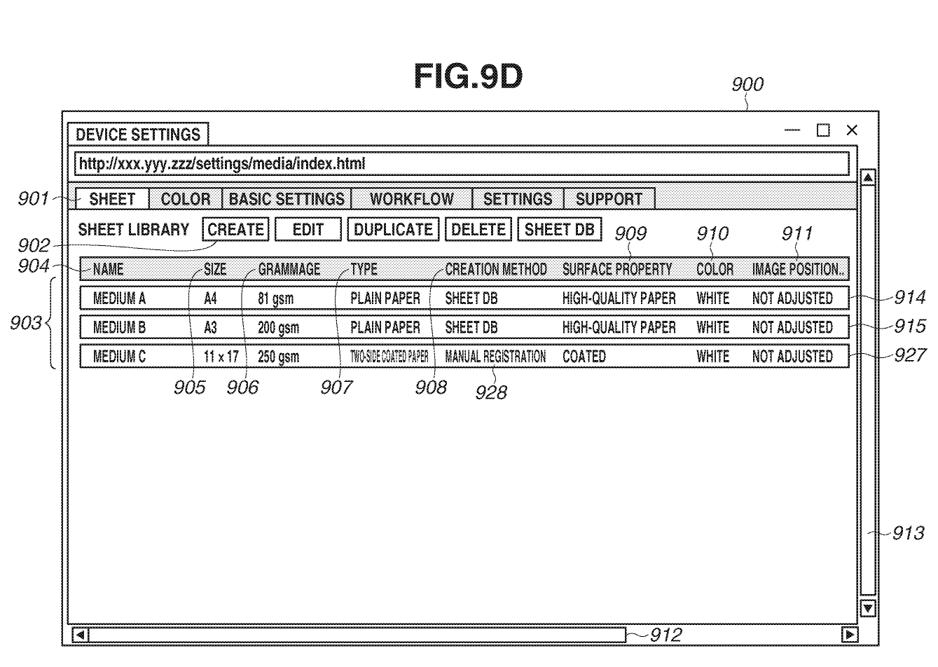

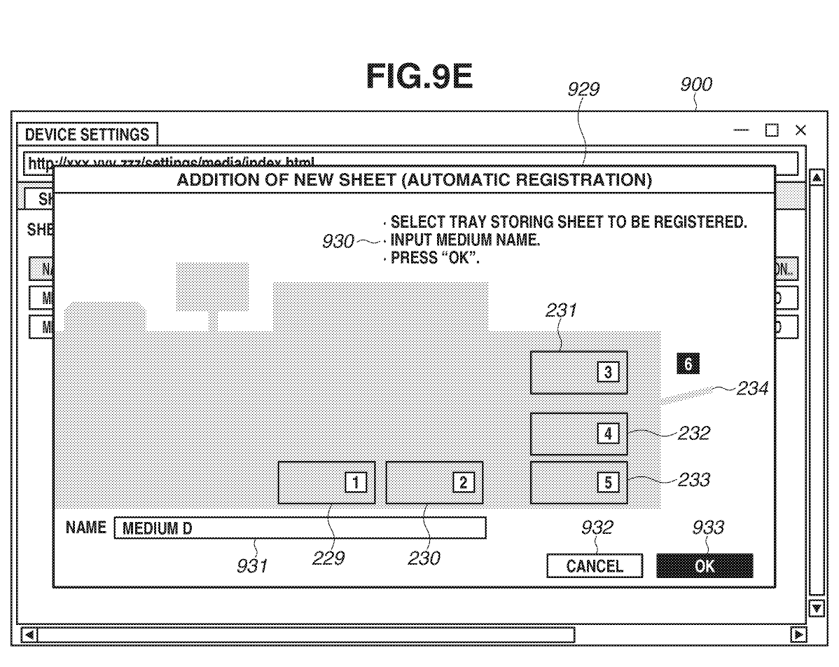

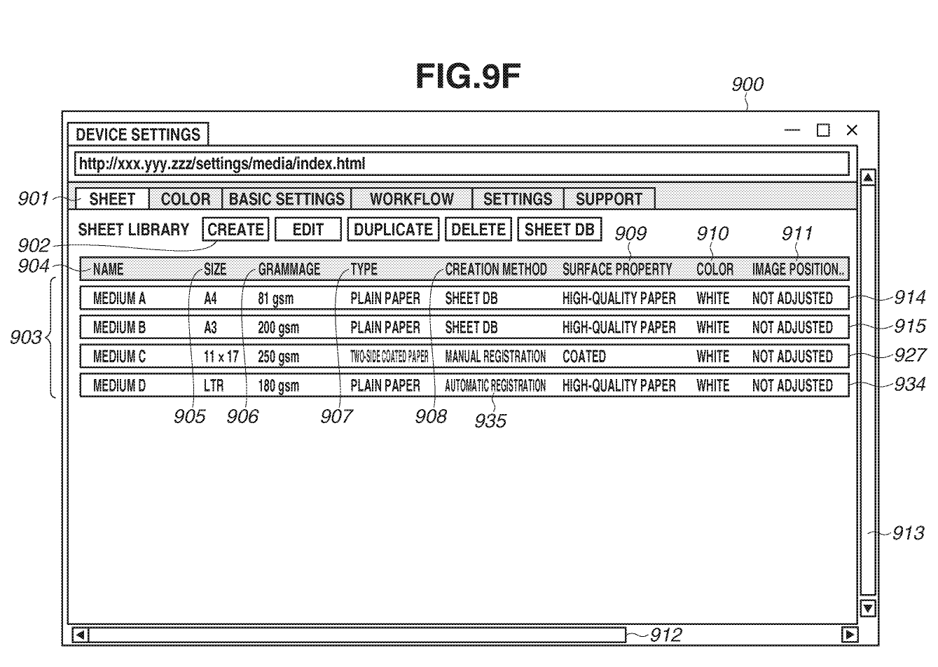

FIGS. 9A-9F are diagrams illustrating an example of a case where, instead of the medium management setting screen illustrated in FIGS. 8A-8M that is achieved by the operation section 204, an equivalent function is provided using the display section 310 included in the PC 102.

FIG. 9A is a diagram for describing the configuration of a second medium management setting screen achieved by the display section 310 included in the PC 102.

The system according to the present embodiment is configured so that various settings and the like of the MFP 101 including medium management settings can be performed mainly using the web browser 506 on the display section 310 of the PC 102. The components of a web browser setting screen 900 illustrated in FIG. 9A are described below. However, a unit for changing information and settings substantially equivalent to that on the operation section 204 illustrated in FIGS. 8A-8M is provided, except that a unit for providing setting target items is the web browser 506 instead of the operation section 204, and the display forms, the display hierarchies, and the like are different from that on the operation section 204. Thus, if portions of the unit for changing information and settings provided in FIGS. 9A-9F have already been described with reference to FIGS. 8A-8M, these portions are not described in detail.

A group of a plurality of setting target function selection tabs is placed in an upper portion of the screen, and the example of FIG. 9A illustrates the state where a "sheet" tab 901 is selected.

In the state where the "sheet" tab 901 is selected as illustrated in FIG. 9A, various sheet-related setting units and medium-related information are presented. A "create" button 902 is used to select a medium when adding the medium and corresponds to the "create" button 818 illustrated in FIGS. 8A-8M. A medium display region 903 corresponds to the medium display region 808 illustrated in FIGS. 8A-8M. However, a display device used for display by the web browser 506 has a displayable region larger than that of the operation section 204 normally included in the MFP 101 and can generally display a large amount of information in a list. Thus, the example of FIG. 9A illustrates a configuration in which more information than that in the medium display region 808 illustrated in FIGS. 8A-8M can be displayed in a list. Further, the system according to the present embodiment is configured so that information that cannot be displayed in the screen illustrated in FIG. 9A due to space limitations can be easily displayed by operating a scroll bar 912.

The example where the scroll bar 912 is in the state illustrated in FIG. 9A illustrates an example where the following medium-related attribute information is provided in FIG. 9A regarding a medium A (914) and a medium B (915). That is, the medium-related attribute information includes a name 904, a size 905, a grammage 906, a type 907, a creation method 908, a surface property 909, a color 910, image position adjustment 911, and the like. In the medium display region 808 in FIGS. 8A-8M, a configuration is employed in which among these pieces of information, the name 904, the size 905, the grammage 906, the type 907, and the creation method 908 are information that can also be viewed in the medium display region 808, whereas other information can be viewed only by selecting the "details/edit" button 817. In contrast, the medium management setting screen using the web browser 506 generally has better in viewability and operability compared to the operation section 204 illustrated in FIGS. 8A-8M.

If the number of media registered in the MFP 101 is a large number, and all the media cannot be displayed in this screen due to space limitations, the media not displayed in this screen can also be displayed and operated by operating a second scroll bar 913.

FIG. 9B illustrates an example of the state of a screen to which a transition is made in a case where the "create" button 902 is selected in the state in FIG. 9A. As illustrated in FIG. 9B, a registration unit selection screen 916 in the registration of a new medium is displayed first. A "manual registration" button 917 corresponds to the "newly create (manual)" button 823 in FIGS. 8A-8M, and an "automatic registration" button 918 corresponds to the "newly create (automatic)" button 824 in FIGS. 8A-8M. If a "cancel" button 919 is selected in FIG. 9B, the processing in FIG. 9B is suspended, and the state in FIG. 9B returns to the state in FIG. 9A. If a "next" button 920 is selected, a transition is made to a further processing screen for registering a medium illustrated in FIG. 9C and subsequent figures.

FIG. 9C illustrates an example of the state of a screen to which a transition is made in a case where the "next" button 920 is selected in the state where the "manual registration" button 917 is selected in FIG. 9B. As illustrated in FIG. 9C, a transition is made to a screen for inputting various medium attributes by the manual registration of a medium. Attribute information 922 regarding a medium illustrated in FIG. 9C corresponds to the various attributes illustrated in FIG. 8F, and therefore is not described in detail. FIG. 9C, however, illustrates the state where "manual registration" 924 is displayed. This is due to the transition to this screen in the state where the "manual registration" button 917 is selected in FIG. 9B.

Attribute information 922 that cannot be displayed in the screen illustrated in FIG. 9C due to space limitations can be displayed and operated by selecting a scroll bar 923. If an "OK" button 926 is selected, a medium is created based on the information set in FIG. 9C. If a "cancel" button 925 is selected, the content of the operation in FIG. 9C is discarded, and a transition is made to the state in FIG. 9A.

FIG. 9D illustrates an example of a screen to which a transition is made in a case where the "OK" button 926 is selected in the state of the screen illustrated in FIG. 9C. As illustrated in FIG. 9D, a medium C (927) that is a new medium is added based on the operations performed up to FIG. 9C, and the creation method 908 of the medium C (927) is "manual registration" 928.

FIG. 9E illustrates an example of the state of a screen to which a transition is made in a case where the "next" button 920 is selected in the state where the "automatic registration" button 918 is selected in the state of the screen illustrated in FIG. 9B. As illustrated in FIG. 9E, a transition is made to a setting screen 929 by the automatic registration of a medium.

As illustrated in FIG. 8I, in the system according to the present embodiment, it is necessary to select a sheet feeding section storing a medium as a registration target when automatic registration is performed. Thus, as illustrated in FIG. 9E, selection buttons for selecting a sheet feeding section (229, 230, 231, 232, 233, and 234) as a target are presented. The example illustrated in FIG. 9E illustrates an example of a case where the button for the tray 6 is selected.

However, as described with reference to FIG. 8J, even in the case of the automatic registration, the name of the medium needs to be specified. Thus, a medium name input region 931 is provided in this screen.

On the setting screen 929 by the automatic registration using the web browser 506, an instruction information presentation section 930 is provided. With this, the system according to the present embodiment makes it easy to improve convenience by providing accompanying instruction information regarding required operations.

If an "OK" button 933 is selected, a medium is created based on the information set in FIG. 9E. If a "cancel" button 932 is selected, the content of the operation in FIG. 9E is discarded, and a transition is made to the state in FIG. 9A.

FIG. 9F illustrates an example of a screen to which a transition is made in a case where the "OK" button 933 is selected in the state of the screen illustrated in FIG. 9E. As illustrated in FIG. 9F, a medium D (934) that is a new medium is added based on the operations performed up to FIG. 9E, and the creation method 908 of the medium D (934) is "automatic registration" 935.

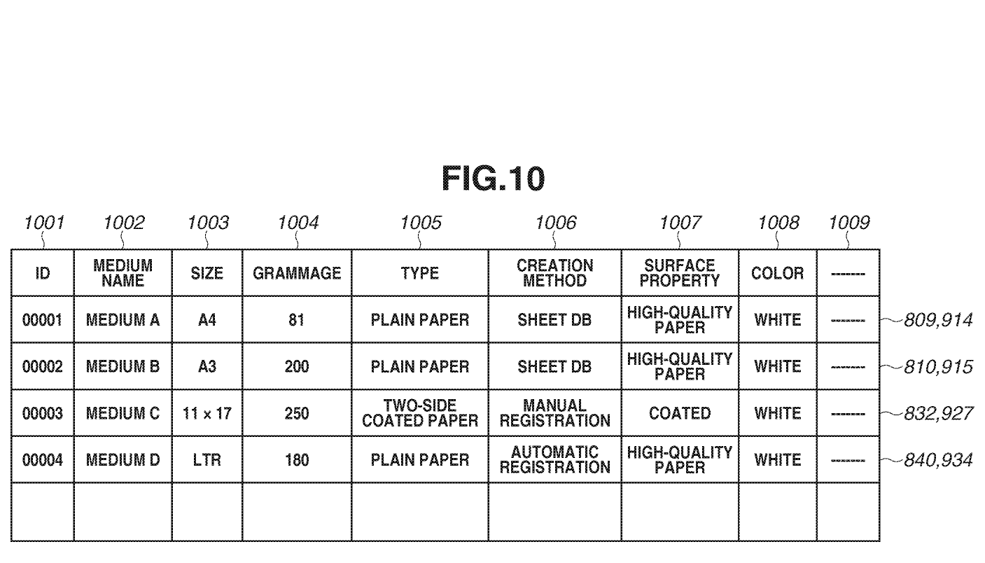

FIG. 10 is a diagram for describing the configuration of a medium management table for storing and managing medium information regarding media registered in the MFP 101 and managed by the medium management program 406. The medium management table stores fields corresponding to a plurality of medium-related attributes. The contents of the fields are described below.

An "ID" field 1001 indicates an identifier uniquely assigned to a medium registered in the MFP 101. The "ID" field 1001 is internally used by the medium management program 406 and is not visualized to the user of the MFP 101.

A "medium name" field 1002 is a region for storing the name of the medium. Uniqueness in operation needs to be ensured in the "medium name" field 1002 so that the user can recognize a desired medium among a plurality of media.

A "size" field 1003 is a region for storing the size of the registered medium. A "grammage" field 1004 is a region for storing the weight per unit area of the registered medium. A "type" field 1005 indicates the type of the registered medium. For example, the "type" refers to plain paper, coated paper coated with a substance that gives glossiness to both sides of the paper, synthetic paper composed of a plastic material, or the like.

A "creation method 1006" field is a field for storing information corresponding to the creation method (816 or 908) in FIGS. 8A-8M or 9A-9F. Control is performed so that a method used to register or create each medium in the MFP 101 can be distinguished based on the value stored in the "creation method 1006" field.

A "surface property" field 1007 is a region for storing information regarding the surface property of the registered medium. The surface property is used by the MFP 101 as information for identifying the surfaces, the states, and the shapes of various media such as high-quality paper, coated paper, embossed paper, and the like.

A "color" field 1008 is a region for storing information regarding the color of the registered medium. The "color" field 1008 is mainly used to store the color of the medium in the case of colored paper.

An "others" field 1009 includes various pieces of information regarding the medium other than the above, and the various pieces of information are stored in the table illustrated in FIG. 10, but are not described in detail.

The example illustrated in FIG. 10 illustrates the contents of the table in the state illustrated in FIGS. 8K or 9F, i.e., the state where the medium A (809 or 914), the medium B (810 or 915), the medium C (832 or 927), and the medium D (840 or 934) are registered.

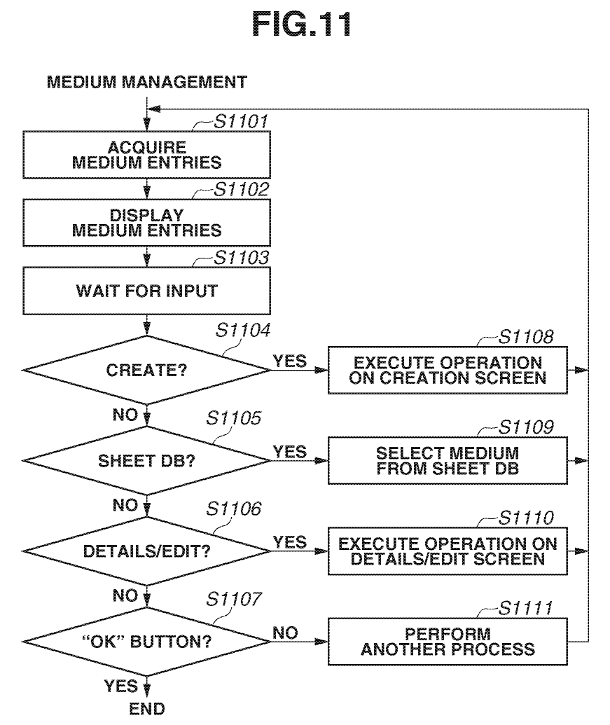

FIG. 11 is a flowchart for describing the operation of the medium management program 406 of the MFP 101 according to the present embodiment. FIG. 11 is achieved by the controller section 205 reading the medium management program 406 from the ROM 207 and executing the medium management program 406. The execution of this flowchart is started using the process of selecting the button 807 illustrated in FIG. 8C as a trigger. FIG. 11 also corresponds to the processing flow of the display of the sheet type management setting screen illustrated in FIGS. 8D, 8H, or 8K and the subsequent figures and the various medium-related operations executed through the screen. A description is given below taking as examples the display state in FIG. 8K and the state of the medium management table in FIG. 10. Although FIGS. 9A-9F also illustrate an example of a case where processes having contents equivalent to those in FIGS. 8A-8M are performed through the web browser 506, the description is given mainly taking the case of FIGS. 8A-8M as an example in the following flow. However, the flow in FIG. 11 is also executed in a case where equivalent operations in FIGS. 9A-9F are executed.

In step S1101, medium entries registered in the MFP 101 are acquired. This corresponds to the process in which the medium management program 406 acquires a list of media registered in the medium management table illustrated in FIG. 10 from the HDD 209.

In step S1102, the medium entries acquired in the immediately preceding step, i.e., step S1101, are displayed. That is, in the example illustrated in FIG. 8K, this process corresponds to the process of displaying the media A, B, C, and D (809, 810, 832, and 840) illustrated in FIG. 8K in the registered medium display region 808 in the form illustrated in FIG. 8K. The details of the operation of step S1102 will be described below.

If the process of step S1102 is completed, the processing proceeds to step S1103. In step S1103, in the example of FIG. 8K, the medium management program 406 is in the state of waiting for an input from an operator in the state where the display in FIG. 8K is performed, and step S1103 is maintained until some input instruction is given. If some input instruction is given, the processing proceeds to step S1104 and subsequent steps.

In step S1104, it is determined whether the content of the instruction input in step S1103 is the selection of the "create" button 818. If the result of the determination in step S1104 is true (YES in step S1104), the processing proceeds to step S1108. In step S1108, an operation on a new medium creation screen is executed. This corresponds to the processes of FIG. 8E and the subsequent figures among FIGS. 8A-8M. The details of the process of step S1108 will be described below.

If the result of the determination in step S1104 is false (NO in step S1104), the processing proceeds to step S1105. In step S1105, it is determined whether the button selected in step S1103 is the sheet database selection button 820. If the result of the determination in step S1105 is true (YES in step S1105), the processing proceeds to step S1109. In step S1109, a process for selecting an appropriate medium from among the media registered in advance in the sheet database and adding the selected medium as a medium entry is executed.

If the result of the determination in step S1105 is false (NO in step S1105), the processing proceeds to step S1106. In step S1106, it is determined whether the button selected in step S1103 is the "details/edit" button 817. If the result of the determination in step S1106 is true (YES in step S1106), the processing proceeds to step S1110. In step S1110, an operation on a detailed screen for viewing and editing the attributes of a selected medium is executed. The details of the process of step S1110 will be described below.

If the result of the determination in step S1106 is false (NO in step S1106), the processing proceeds to step S1107. In step S1107, it is determined whether the content of the instruction input in step S1103 is the selection of the "OK" button 821. If the result of the determination in step S1107 is true (YES in step S1107), the flow illustrated in FIG. 11 ends. If the result of the determination in step S1107 is false (NO in step S1107), this is a situation where an operation unit provided in FIG. 8K and corresponding to none of the above is selected. Thus, the processing proceeds to step S1111. In step S1111, the corresponding operation unit is executed. The content of the specific operation process included in step S1111 is not described.

If the process of step S1108, S1109, S1110, or S1111 is completed and the corresponding process is completed, the processing returns to step S1101 and returns to the acquisition process for acquiring medium entries registered in the MFP 101. If the process of adding medium information or the like is executed at this stage, the display state is also updated by executing the processes of step S1101 and the subsequent steps again according to the content of this change.

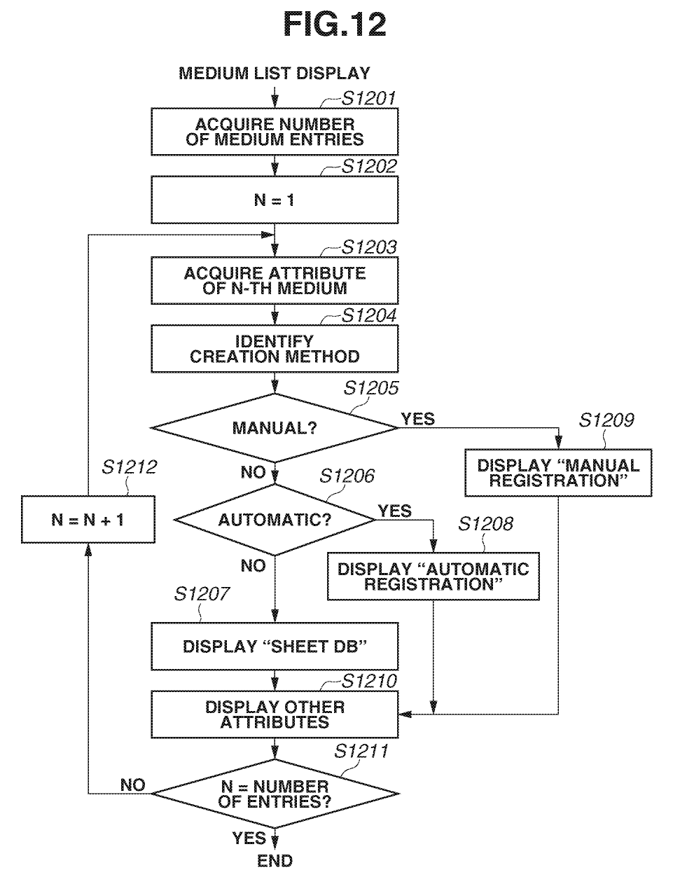

FIG. 12 is a flowchart for describing the details of step S1102 in FIG. 11, i.e., the display process for displaying medium information regarding the medium entries registered in the MFP 101. This flowchart is achieved by the controller section 205 reading the medium management program 406 from the ROM 207 and executing the medium management program 406.

In step S1201, the medium management program 406 acquires the number of the medium entries registered in the MFP 101. Specifically, the number of effective medium entries stored in the medium management table in FIG. 10 is acquired by an inspection.

Step S1202 and subsequent steps form a loop process. In step S1202, the counter of the loop is initialized to 1, and the processing proceeds to step S1203.

In step S1203, attribute information regarding a medium as a reference target is acquired. This corresponds to the process of acquiring the values of the attributes (1001 to 1009) regarding a medium as an inspection target stored in the medium management table in FIG. 10.

In step S1204, information regarding the creation method 1006 in the attribute information regarding the medium acquired in step S1203 is identified, and the value of the creation method 1006 is identified. The result of the identification is distinguished in steps S1205 and subsequent steps.

In step S1205, it is determined whether the value of the creation method 1006 of the medium identified in step S1204 is manual registration. If the result of the determination in step S1205 is true (YES in step S1205), the processing proceeds to step S1209. In step S1209, the process of displaying "manual registration" as the registration unit information regarding the currently processed medium on the sheet type management setting screen is executed. Specifically, a field portion for the creation method 816 of the medium C (832) in FIG. 8K is displayed in the form illustrated in FIG. 8K. Consequently, the medium C (832) can be displayed in a form in which it can be identified that the medium C (832) is created by manual registration.

If the result of the determination in step S1205 is false (NO in step S1205), the processing proceeds to step S1206. In step S1206, it is determined whether the value of the creation method 1006 of the medium identified in step S1204 is automatic registration. If the result of the determination in step S1206 is true (YES in step S1206), the processing proceeds to step S1208. In step S1208, the process of displaying "automatic registration" as the registration unit information regarding the currently processed medium on the sheet type management setting screen is executed. Specifically, a field portion for the creation method 816 of the medium D (840) in FIG. 8K is displayed in the form illustrated in FIG. 8K. Consequently, the medium D (840) can be displayed in a form in which it can be identified that the medium D (840) is created by automatic registration.

If the result of the determination in step S1206 is false (NO in step S1206), this corresponds to a case where the value of the creation method 1006 of the medium identified in step S1204 is neither automatic registration nor manual registration. Thus, it is determined that a value that can be taken by the creation method 1006 in this case is sheet database. Thus, the processing proceeds to step S1207. In step S1207, the process of displaying "sheet database" as the registration unit information regarding the currently processed medium on the sheet type management setting screen is executed. Specifically, a field portion for the creation method 816 of the medium A or B (809 or 810) in FIG. 8K is displayed in the form illustrated in FIG. 8K. Consequently, the medium A or B (809 or 810) can be displayed in a form in which it can be identified that the medium A or B (809 or 810) is registered from the sheet database.

If the process of step S1207, S1208, or S1209 is completed, the processing proceeds to step S1210. In step S1210, the attributes other than the creation method regarding the currently processed medium are displayed on the sheet type management setting screen. By the execution of the processes up to step S1207, a display process regarding a single medium entry is executed on the sheet type management setting screen.

The processes of steps S1203 to S1210 are repeatedly applied to all the medium entries registered in the medium management table. To this end, in step S1211, a determination process for determining a loop end condition is executed, and in step S1212, a process for selecting a medium entry to be processed next is executed. If the loop process is to be continued, the processing returns to step S1203, and the above processes are repeatedly executed.

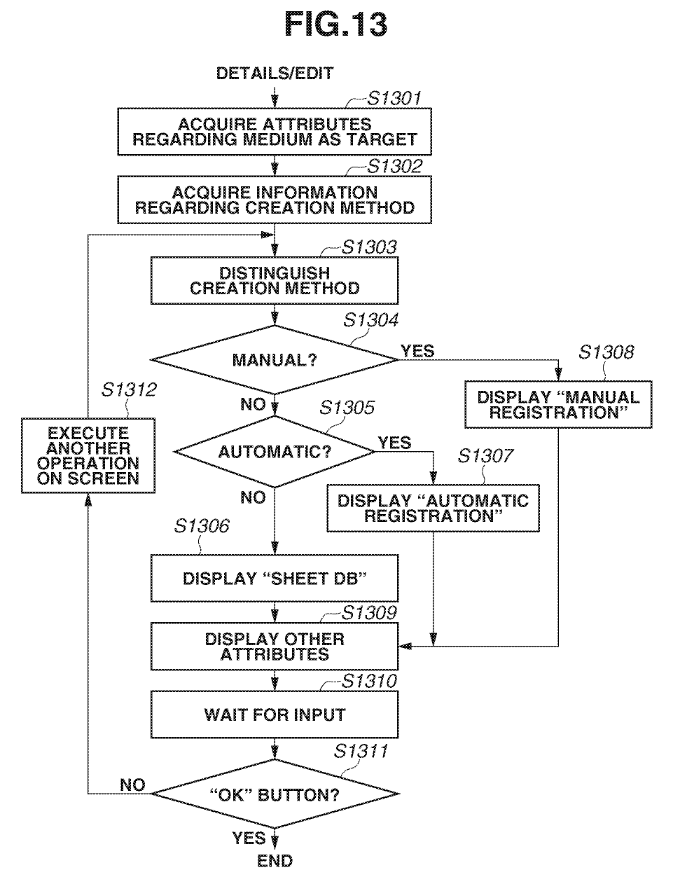

FIG. 13 is a flowchart for describing step S1110 in FIG. 11, i.e., the execution of an operation on a screen for viewing and editing the attributes of a particular selected medium among the medium entries registered in the MFP 101. This flowchart is achieved by the controller section 205 reading the medium management program 406 from the ROM 207 and executing the medium management program 406.

In step S1301, the attributes regarding the medium as the viewing and editing target among the media managed by the medium management program 406 are acquired. In step S1302, the value of the creation method among the acquired attributes is identified. In step S1303, the creation method is distinguished. The information regarding the creation method identified in the processes up to step S1303 is distinguished in the processes of step S1304 and subsequent steps and used in display control of fields of the creation method 827 illustrated as an example in FIGS. 8F or 8L.

That is, if the result of the determination in step S1304 is true (YES in step S1304), i.e., if the creation method distinguished in step S1303 is manual registration, display control is performed to display the creation method 827 as "manual registration" 828 in the display information in FIGS. 8F or 8L.

If the result of the determination in step S1304 is false (NO in step S1304) and the result of the determination in step S1305 is true (YES in step S1305), i.e., if the creation method distinguished in step S1303 is automatic registration, display control is performed to display the creation method 827 as "automatic registration" 841 in the display information in FIGS. 8F or 8L.

If the results of the determinations in steps S1304 and S1305 are both false (NO in step S1304 and NO in step S1305), the creation method is distinguished as the sheet database. Thus, display control is performed to display the creation method 827 as "sheet DB" in the display information in FIGS. 8F or 8L.

As illustrated above in steps S1306, S1307, and S1308, control is performed so that the difference in the method used to create the medium to be viewed or edited can be distinguished according to the difference in the value of the creation method of the medium.

In step S1309, a display process for displaying the items other than the creation method 827 is performed. The state of the screen at the stage where the processes up to step S1309 are completed is a state corresponding to FIGS. 8F or 8L.

In step S1310, the medium management program 406 is in the state of waiting for an input, and step S1310 is maintained until some operation is performed in the state of the screen in FIGS. 8F or 8L.

After some operation is performed on the screen, the processing proceeds to step S1311. In step S1311, it is determined whether this screen transition is executed by selecting the "OK" button 831. If the result of the determination in step S1311 is true (YES in step S1311), the flow illustrated in FIG. 13 ends.

If the result of the determination in step S1311 is false (NO in step S1311), this means that an appropriate operation other than the selection of the "OK" button 831 is performed in FIGS. 8F or 8L. As an example, this corresponds to the editing of the displayed items, an operation on the scroll buttons 830, or the like. In these cases, the processing proceeds to step S1312. In step S1312, the corresponding process is executed, and the state of the screen is updated to display the result according to the operation. Then, the processing returns to step S1303. The content of the process performed in step S1312 is not described in detail.

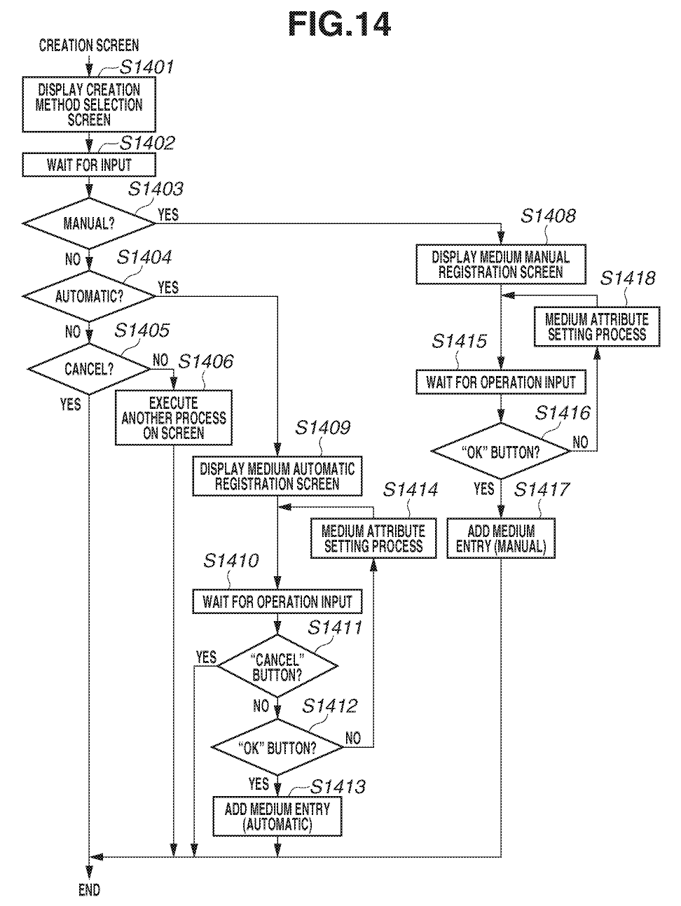

FIG. 14 is a flowchart for describing step S1108 in FIG. 11, i.e., the execution of an operation on the medium creation process screen on the MFP 101. The medium creation process screen is as illustrated in FIG. 8E. The flow in FIG. 14 is achieved by the controller section 205 reading the medium management program 406 from the ROM 207 and executing the medium management program 406.

In step S1401, a display process for displaying a creation method selection screen is performed. This corresponds to the process of displaying the screen illustrated in FIG. 8E. In step S1402, the medium management program 406 waits for an input, and the process of step S1402 is maintained until an instruction to perform some operation is given to the screen in FIG. 8E.

In step S1403, the operation selected in step S1402 is distinguished, and it is determined whether the operation is an instruction given to the "newly create (manual)" button 823. If the result of the determination in step S1403 is true (YES in step S1403), the processing proceeds to step S1408 and subsequent steps. Then, a series of display operations and the operation based on the specified instruction regarding a manual registration process are performed. The process of step S1408 corresponds to the screen transition and the medium registration process illustrated in the description with reference to FIGS. 8E, 8F, 8G, and 8H.

If the result of the determination in step S1403 is false (NO in step S1403), the processing proceeds to step S1404. In step S1404, it is determined whether the operation selected in step S1402 is an instruction given to the "newly create (automatic)" button 824. If the result of the determination in step S1404 is true (YES in step S1404), the processing proceeds to step S1409 and subsequent steps. Then, a series of display operations and the operation based on the specified instruction regarding an automatic registration process are performed. The process of step S1409 corresponds to the screen transition and the medium registration process illustrated in the description with reference to FIGS. 8E, 8I, 8J, and 8K.

If the result of the determination in step S1404 is false (NO in step S1404), the processing proceeds to step S1405. In step S1405, it is determined whether the operation selected in step S1402 is an instruction given to the "cancel" button 825. If the result of the determination in step S1405 is true (YES in step S1405), this flow ends. Then, the execution of the medium registration process is suspended.

If the result of the determination in step S1405 is false (NO in step S1405), this corresponds to an instruction to execute any process other than the registration processes and the cancellation process. For example, this corresponds to a case where the "create by duplication" button 822 in FIG. 8E is selected or the like. In this case, the processing proceeds to step S1406. In step S1406, a process corresponding to the instruction is executed, but is not described in detail.

The flow in step S1409 and the subsequent steps is further described below.

In step S1409, a series of screen display operations and a screen transition process regarding a medium automatic registration screen are executed. This corresponds to a display operation for displaying various setting items derived from the medium automatic registration process illustrated in FIGS. 8I and 8J.

In step S1410, if the medium management program 406 waits in the state of waiting for an input, and it is determined that some input is received, then in step S1411, first, it is determined whether the "cancel" button (835 or 838) is selected. If the result of the determination in step S1411 is true (YES in step S1411), the medium automatic registration process performed up to step S1410 is suspended, and the flow in FIG. 14 ends.

If the result of the determination in step S1411 is false (NO in step S1411), the processing proceeds to step S1412. In step S1412, it is determined whether the instruction input in step S1410 is the selection of the "OK" button 839. If the result of the determination in step S1412 is false (NO in step S1412), since various setting operations regarding the automatic registration process are continued, the processing proceeds to step S1414. In step S1414, a corresponding setting operation is performed. Then, the processing returns to step S1410.

If the result of the determination in step S1412 is true (YES in step S1412), then in step S1413, the medium automatic registration process performed up to step S1412 is received, and a medium corresponding to the medium management table illustrated in FIG. 10 is registered as a medium regarding which the creation method 1006 is automatic registration. Then, the flow in FIG. 14 ends. Specifically, at the stage where the flow up to FIG. 8J is executed and the "OK" button 839 is pressed, the medium D (840 or 934) in FIG. 10 is registered.

Next, the flow in step S1408 and the subsequent steps is further described below.

In step S1408, a series of screen display operations and a screen transition process regarding a medium manual registration screen are executed. This corresponds to a display operation for displaying various setting items derived from the medium manual registration process illustrated in FIGS. 8F and 8G.

In step S1415, if the medium management program 406 waits in the state of waiting for an input, and it is determined that some input is received, then in step S1416, it is determined whether the content of the input instruction is the selection of the "OK" button 831. If the result of the determination in step S1416 is false (NO in step S1416), since various setting operations regarding the manual registration process are continued, the processing proceeds to step S1418. In step S1418, a corresponding setting operation is performed. Then, the processing returns to step S1415.

If the result of the determination in step S1416 is true (YES in step S1416), then in step S1417, the medium manual registration process performed up to step S1416 is received, and a medium corresponding to the medium management table illustrated in FIG. 10 is registered as a medium regarding which the creation method 1006 is manual registration. Then, the flow in FIG. 14 ends. Specifically, at the stage where the flow up to FIG. 8G is executed and the "OK" button 831 is pressed, the medium C (832 or 927) in FIG. 10 is registered.

This is the description of the first embodiment of the present disclosure. Generally, an MFP having a medium management function is operated such that an operator having administrator authority mainly performs management such as the registration of a medium in the MFP and the like. That is, the operator grasps the properties of a wide variety of media, sets an appropriate attribute value and an appropriate setting value regarding a medium through the medium management function included in the MFP, makes various adjustments, and registers the medium in the MFP. This management operation is normally performed by an operator (an administrator) with knowledge and skills about media. It is possible to produce an appropriate final product with a desired quality by using the medium thus registered in the MFP.

However, to appropriately perform a series of processes regarding medium management such as medium registration and the like as described above, advanced skills and knowledge and adjustment operations are required, and therefore, this is not a simple operation. Thus, even if the MFP has the medium management function, an appropriate medium registration process that can be provided to generate a final product with an appropriate quality is not simple for an operator without skills to appropriately handle as part of the medium management function.

As one measure for solving the above issue, there is an MFP including a medium sensor that measures the physical characteristics of a medium, such as the surface property, the weight, the thickness, and the like of the medium, using sensors and distinguishes the type of the medium based on the results of the measurements. In the case of the MFP including the medium sensor, even an operator without skills and knowledge about a series of medium registration operations, adjustments, and the like included in the medium management function can automatically register an appropriate medium in the MFP and execute a final product generation process using the appropriate medium more easily.

However, in a case where an automatic medium registration unit using a medium sensor is included in addition to a medium management registration unit using a conventional medium management function, the following issue further arises.

As described above, a medium registration/management process using the conventional medium management function is mainly executed by an administrator with skills and knowledge. A medium registered by the administrator is registered in the MFP as a set of medium parameters in the state where the medium parameters are optimally adjusted so that an appropriate final product can be generated.

On the other hand, in a case where an operator without skills and knowledge performs a medium registration process for registering a medium using a medium sensor, unlike the above medium registered by the administrator, this medium is not highly adjusted, and is registered in a simple state in the MFP. In other words, the medium is registered in the MFP as a set of medium parameters in the state where the medium parameters are not optimally adjusted.

A case is assumed where in this state, an appropriate medium is selected from among registered media and a final product generation process is performed using the MFP. In an MFP in the conventional art, it is difficult to identify which of a plurality of media displayed in a list is simply registered by a medium sensor. Thus, it is possible to solve this issue by executing the above processing.

### Second Embodiment

In the first embodiment, the following technique has been illustrated. When a new medium is created by the medium management program 406 of the MFP 101, information regarding a creation method can be displayed in a distinguishable form, whereby it is possible to easily distinguish by which of manual registration and automatic registration the medium is registered. Consequently, an appropriate medium can be selected when a medium is used.

Even a medium registered by a simple method based on automatic registration can also be subjected to various adjustments corresponding to those described with reference to FIG. 7 by an operator with skills after the registration of the medium, then corrected to a set of attributes of an optimized medium, and registered again.

Moreover, a skilled person can also positively perform simple automatic registration, then make various adjustments corresponding to those described with reference to FIG. 7, and register an optimized medium.

In these cases, even if a medium is automatically registered when initially registered, the medium ultimately becomes equivalent to a medium created by manual registration and is registered as an optimized medium in the MFP 101.

A second embodiment of the present disclosure relates to a system for storing a creation method used when a medium is created in association with the medium, and simultaneously, enabling the medium to be re-registered as manual registration as a result of an adjustment/correction process being performed on the medium after the creation.

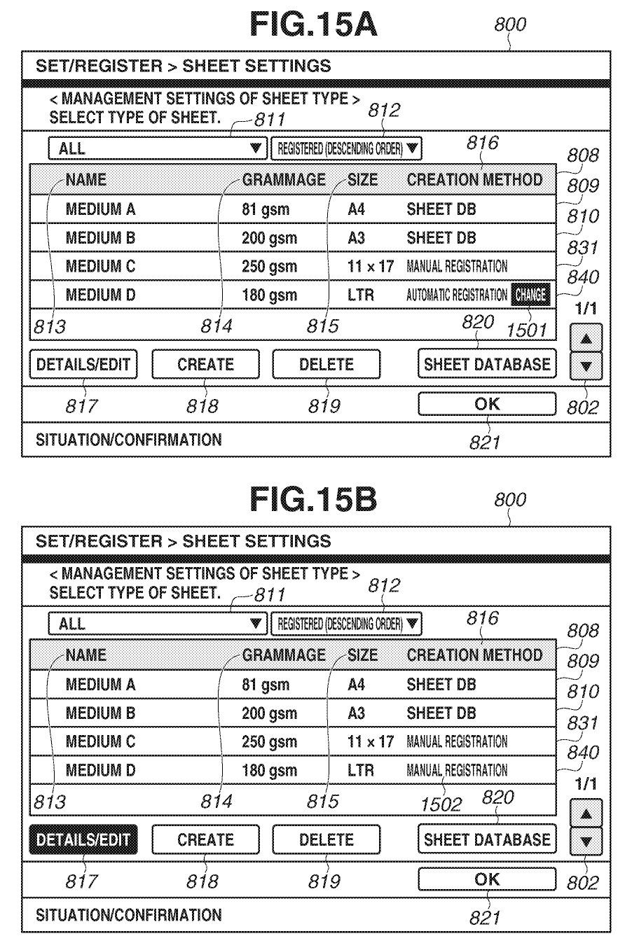

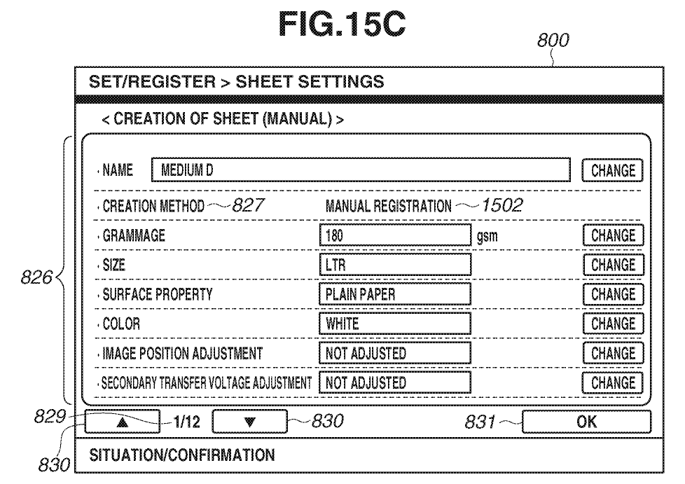

FIG. 15A illustrates an example of the medium display region 808 according to the second embodiment of the present disclosure and corresponds to FIG. 8K in the first embodiment.

As illustrated in FIG. 15A, a "change" button 1501 is placed for the medium D (840) that is an automatically registered medium in the list in the medium display region 808. By selecting the "change" button 1501, the user of the MFP 101 or the medium explicitly performs a selection operation for selecting the "change" button 1501 even if the medium is a medium automatically registered when initially registered. Consequently, the MFP 101 according to the second embodiment is controlled so that the medium is changed to a medium equivalent to a medium created by manual registration.

FIG. 15B illustrates an example of the state of a screen to which a transition is made immediately after the "change" button 1501 is selected in the state of the screen in FIG. 15A. As illustrated in FIG. 15B, as a result of selecting the "change" button 1501, the creation method 816 of the medium D (840) is changed to manual registration.

FIG. 15C illustrates an example of an editing screen for editing the medium attributes displayed immediately after the "details/edit" button 817 is further selected in the state of the screen in FIG. 15B. Also in FIG. 15C, information regarding the creation method 827 is changed to "manual registration" 1502.

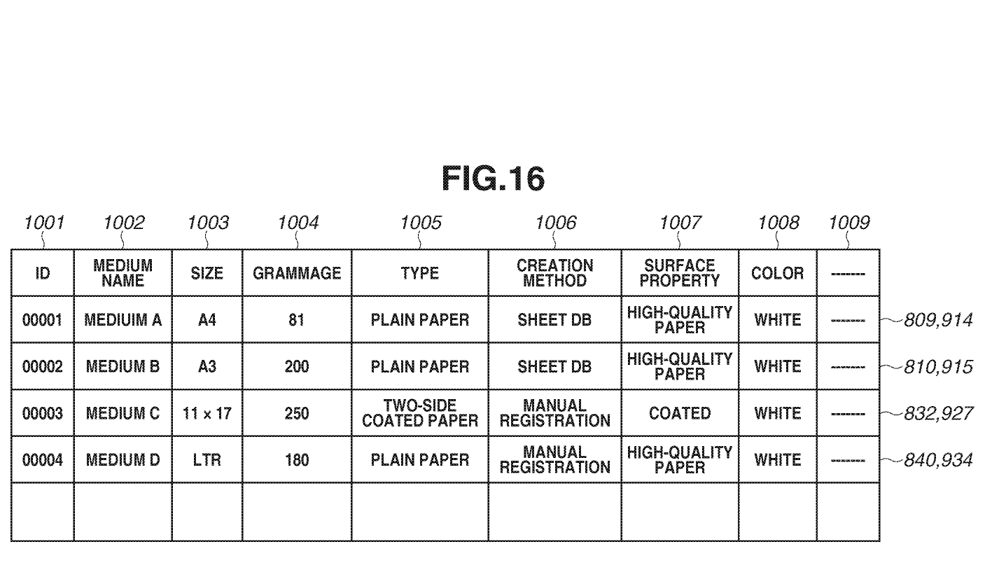

FIG. 16 illustrates an example of the internal state of the medium management table at the stage where the series of operations up to FIG. 15C is performed. FIG. 16 corresponds to FIG. 10 in the first embodiment. As illustrated in FIG. 16, the attribute value of the creation method 1006 of the medium D (840 or 934) in the medium management table is changed from automatic registration to manual registration.

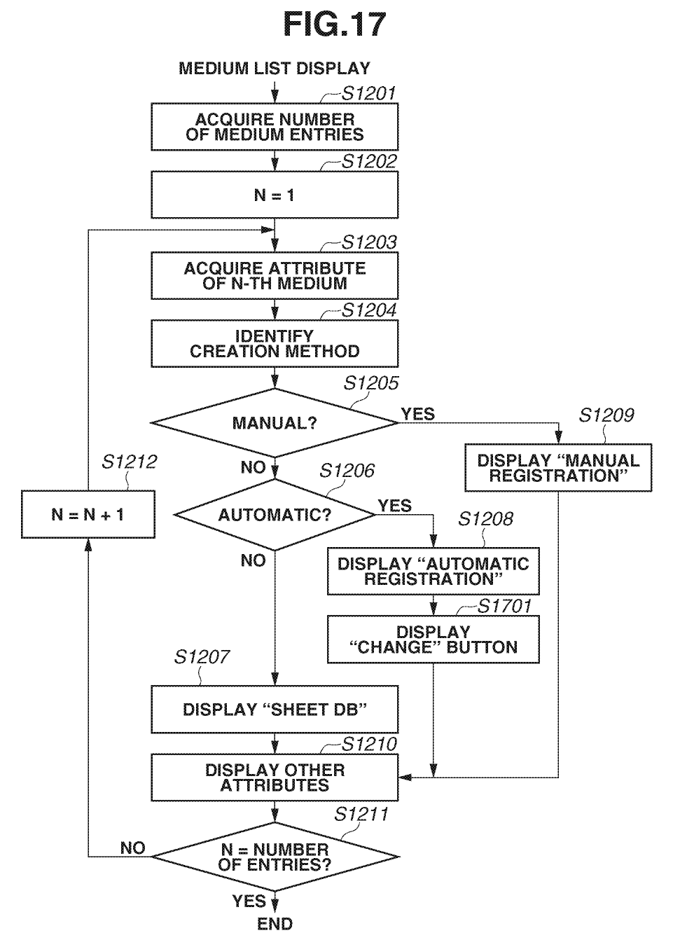

FIG. 17 is a flowchart for describing the details of the display process for displaying medium information regarding the medium entries registered in the MFP 101 according to the second embodiment of the present disclosure and corresponds to FIG. 12 in the first embodiment. Only portions different from the flowchart described with reference to FIG. 12 are mainly described below.

In step S1206, the creation method of the medium to be displayed is distinguished. Specifically, it is determined whether the medium is a medium registered by automatic registration. If the result of the determination in step S1206 is true (YES in step S1206), the processing proceeds to step S1208. In step S1208, the process of displaying "automatic registration" as the registration unit information regarding the currently processed medium on the sheet type management setting screen is executed. The process of step S1208 is as illustrated in FIG. 12.

Next, in step S1701, the "change" button 1501 is displayed. As illustrated in FIG. 15A, this is the step of executing a process for providing the "change" button 1501 as an instruction unit for changing an automatically registered medium to manual registration in the second embodiment of the present disclosure.

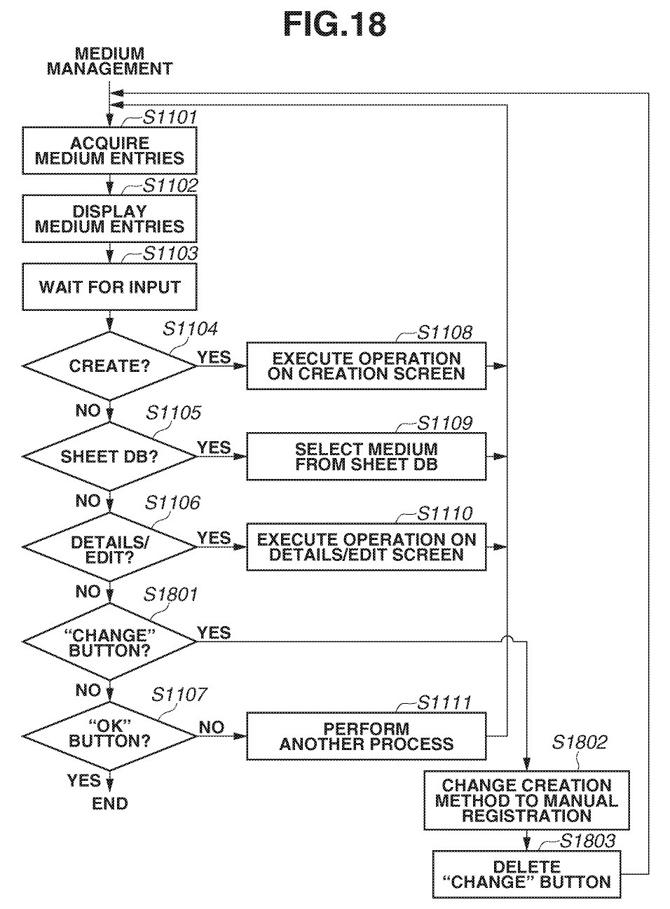

FIG. 18 is a flowchart for describing the operation of the medium management program 406 of the MFP 101 according to the second embodiment of the present disclosure and corresponds to FIG. 11 in the first embodiment. Only portions different from the flowchart described with reference to FIG. 11 are mainly described below.

In step S1801, the process of determining whether the "change" button 1501 is selected in addition to the selection unit in the screen selected in FIGS. 8D, 8H, or 8K determined up to step S1106 is executed. If the result of the determination in step S1801 is true (YES in step S1801), the processing proceeds to step S1802. In step S1802, the creation method corresponding to the medium for which the "change" button 1501 is selected is changed to manual registration. Specifically, the value of the creation method 1006 of the medium illustrated in FIG. 16 is changed to manual registration. Next, since an operation on the "change" button 1501 is unnecessary regarding the medium already changed to manual registration, in step S1803, the "change" button 1501 in the display state is deleted.

As illustrated above, even if the MFP 101 is controlled so that a creation method of a medium can be identified, but if it is necessary to change the creation method for a predetermined purpose, the creation method used to register the medium can be changed by an editing operation for editing the medium.

### Third Embodiment

A configuration can be employed in which whether to execute the change process for changing the creation method illustrated in the second embodiment can be variably controlled according to the authority of an operator. That is, control can be performed so that in a case where a simply automatically registered medium is changed to manual registration, only a user with skills to optimally bring the medium into an adjusted state is allowed to perform the above operation.

To this end, in a third embodiment of the present disclosure, a system capable of variably controlling whether to display or hide the "change" button 1501 according to a user and authority in a user management function provided by the MFP 101 is provided.

### Fourth Embodiment

The above embodiments relate to a technique for processing and displaying information regarding a creation method selected to create a medium by displaying the information in a form in which the information can be identified on an operation section. However, there can also be a case where the information does not need to be identifiably displayed, such as a case where users are limited in the use environment of the MFP 101, or a case where medium-related knowledge or skills are limited, or the like.

In this case, a system capable of performing control to hold the information regarding the creation method used to create the medium as information, but prevent the display of the information on an operation section where necessary is also possible. A fourth embodiment of the present disclosure relates to a system capable of variably controlling whether to display or hide the creation method.

### Fifth Embodiment

A fifth embodiment of the present disclosure relates to a system capable of selectively applying whether to perform a particular process according to the type of the creation method of the medium. It is possible to achieve a case where a particular process is collectively applied to only media created by manual registration or automatic registration, or the like. An example of the above process corresponds to the process of holding only medium information generated by any of collectively selected creation methods for the purpose of backup in an external apparatus or importing the medium information to another MFP and making use of the settings of the medium information, or the like.

It is possible to make it easy for a user to select desired sheet information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064131, filed Apr. 9, 2025, which is hereby incorporated by reference herein in its entirety.

What is claimed is:

1. An image forming apparatus comprising:
at least one memory storing instructions; and
at least one processor that, upon execution of the stored instructions, configures the at least one processor to operate as:
a measurement unit configured to measure properties of a sheet;
a registration unit configured to register sheet information;
a display unit configured to display a plurality of pieces of sheet information registered by the registration unit; and
a printing unit configured to print an image on a sheet based on sheet information selected from the displayed plurality of pieces of sheet information,
wherein the display unit displays sheet information registered by the measurement unit measuring properties of a sheet as automatically registered sheet information and displays sheet information registered through a setting performed by a user without the measurement unit measuring the properties of a sheet as manually registered sheet information, and
wherein, in a case where a parameter of the sheet information displayed as the automatically registered sheet information is changed by the user inputting a parameter, the display unit displays the sheet information as the manually registered sheet information.

2. The image forming apparatus according to claim 1, wherein the display unit displays sheet information registered by duplicating the sheet information displayed as the automatically registered sheet information as the automatically registered sheet information.

3. The image forming apparatus according to claim 1, wherein the sheet information includes a grammage of the sheet, a type of the sheet, a size of the sheet, and a secondary transfer voltage.

4. The image forming apparatus according to claim 1, wherein the measurement unit measures a grammage of the sheet.

5. The image forming apparatus according to claim 4, wherein the measurement unit further measures a type of the sheet.

6. The image forming apparatus according to claim 5, wherein the measurement unit is a medium sensor.

7. The image forming apparatus according to claim 1,
wherein, among the plurality of pieces of sheet information registered by the registration unit, in a case where a name of sheet information registered by the measurement unit measuring properties of a sheet and a name of sheet information registered through a setting performed by the user without the measurement unit measuring properties of a sheet are identical or similar to each other, the display unit displays the sheet information registered by the measurement unit measuring the properties of the sheet and the sheet information registered through the setting performed by the user without the measurement unit measuring the properties of the sheet in a manner that enables their registration methods to be distinguished, and
wherein, among the plurality of pieces of sheet information registered by the registration unit, in a case where a name of sheet information registered by the measurement unit measuring properties of a sheet and a name of sheet information registered through a setting performed by the user without the measurement unit measuring properties of a sheet are neither identical nor similar to each other, the display unit displays the sheet information registered by the measurement unit measuring the properties of the sheet and the sheet information registered through the setting performed by the user without the measurement unit measuring the properties of the sheet, without displaying their registration methods.

8. A display method comprising:
measuring properties of a sheet;
registering sheet information; and
displaying a plurality of pieces of sheet information registered in the registering,
wherein in the displaying, sheet information registered by measuring properties of a sheet in the measuring is displayed as automatically registered sheet information and sheet information registered through a setting performed by a user without measuring the properties of a sheet in the measuring is displayed as manually registered sheet information, and
wherein in the displaying, in a case where a parameter of the sheet information displayed as the automatically registered sheet information is changed by the user inputting a parameter, the sheet information is displayed as the manually registered sheet information.

9. The display method according to claim 8, wherein in the displaying, sheet information registered by duplicating the sheet information displayed as the automatically registered sheet information is displayed as the automatically registered sheet information.

10. The display method according to claim 8, wherein the sheet information includes a grammage of the sheet, a type of the sheet, a size of the sheet, and a secondary transfer voltage.

11. The display method according to claim 8, wherein, in the measuring, a grammage of the sheet is measured.

12. The display method according to claim 11, wherein, in the measuring, a type of the sheet is further measured.

13. The display method according to claim 12, wherein, in the measuring, measurement is performed using a medium sensor.

14. A non-transitory computer readable storage medium storing a program for causing a computer to execute a display method, the display method comprising:
measuring properties of a sheet;
registering sheet information; and
displaying a plurality of pieces of sheet information registered in the registering,
wherein in the displaying, sheet information registered by measuring properties of a sheet in the measuring is displayed as automatically registered sheet information and sheet information registered through a setting performed by a user without measuring the properties of a sheet in the measuring is displayed as manually registered sheet information, and
wherein in the displaying, in a case where a parameter of the sheet information displayed as the automatically registered sheet information is changed by the user inputting a parameter, the sheet information is displayed as the manually registered sheet information.
